(19) United States
(12) Patent Application Publication
(10) Pub. No.: US 2024/0012415 A1
(43) Pub. Date: Jan. 11, 2024

(54) TRUE VISION AUTONOMOUS MOBILE SYSTEM

(71) Applicant: Newton Howard, Potomac, MD (US)

(72) Inventor: Newton Howard, Potomac, MD (US)

(21) Appl. No.: 18/473,253

(22) Filed: Sep. 24, 2023

Related U.S. Application Data
(63) Continuation-in-part of application No. 18/334,826, filed on Jun. 14, 2023.
Application No. 18/334,826 is a continuation-in-part of application No. 18/194,281, filed on Mar. 31, 2023.
Application No. 18/194,281 is a continuation-in-part of application No. 17/524,407, filed on Nov. 11, 2021.
(60) Provisional application No. 63/409,515, filed on Sep. 23, 2022.
(60) Provisional application No. 63/413,229, filed on Oct. 4, 2022.
(60) Provisional application No. 63/351,957, filed on Jun. 14, 2022.
(60) Provisional application No. 63/325,997, filed on Mar. 31, 2022.
(60) Provisional application No. 63/250,207, filed on Sep. 29, 2021.

(51) Int. Cl. G05D 1/00; G06T 5/00; H04N 25/60; B60W 50/14

(52) U.S. Cl. CPC G05D 1/0088; G06T 5/002; H04N 25/60; B60W 50/14; G05D 1/0038; B60W 2050/146

(57) ABSTRACT

Embodiments may provide techniques for an alternative and innovative approach to autonomous systems using two already existing senses: video and audio signals. For example, in an embodiment, a mobile system may comprise a vehicle, vessel, or aircraft comprising a plurality of video sensors, and a plurality of audial sensors, adapted to obtain information about surroundings of the vehicle, vessel, or aircraft and to transmit video and audial data representing the information about surroundings of the vehicle, vessel, or aircraft, and at least one computer system adapted to receive the video and audial data from the plurality of sensors, perform fusion of the received data to generate information representing the surroundings of the vehicle, vessel, or aircraft, and to use the generated information to provide autonomous functioning of the vehicle, vessel, or aircraft.

### CROSS-REFERENCE TO RELATED APPLICATIONS

This application claims the benefit of U.S. Provisional Application No. 63/409,515, filed Sep. 23, 2022, and U.S. Provisional Application No. 63/413,229, filed Oct. 4, 2022, and is a continuation-in-part of U.S. patent application Ser. No. 18/334,826, filed Jun. 14, 2023, which claims the benefit of U.S. Provisional Application No. 63/351,957, filed Jun. 14, 2022, which is a continuation-in-part of U.S. patent application Ser. No. 18/194,281, filed Mar. 31, 2023, which claims the benefit of U.S. Provisional Application No. 63/325,997, filed Mar. 31, 2022, and which is a continuation-in-part of U.S. patent application Ser. No. 17/524,407, filed Nov. 11, 2021, which claims the benefit of U.S. Provisional Application No. 63/250,207, filed Sep. 29, 2021, the contents of all of which are incorporated herein in their entirety.

### BACKGROUND

The present invention relates to techniques for operating autonomous systems with improved autonomy so as to operate largely, or even completely, autonomously.

Autonomous systems are system that perform behaviors or tasks with a high degree of autonomy. Conventional theories and technologies of autonomous systems emphasize human-system interactions and humans in-the-loop, and so are not completely, or even mainly, autonomous. Further, conventional approaches to autonomous vehicles emphasize the application of RADAR and LIDAR technologies. Despite the various advantages of these technologies, there are various drawbacks, such as system size, weather dependence, investment in purchase and repair, etc.

Typically, it is enough to evaluate three characteristics to more or less adequately obtain an overall assessment of the quality of an autonomously piloted vehicle (autopilot): 1. Disrate (disengagement rate, takeover rate)—the most complex and vital numerical indicator to evaluate, which summarizes the quality of decisions made by the autopilot, usually measured in the number of failures per one kilometer of distance traveled. The dream of every developer is to reach zero. There is another obvious nuance: the smaller the disrate value, the more mileage is needed to confirm its correctness. 2. Unit cost of scaling —how much it will cost to get the autopilot to function successfully on a new kilometer of a road. 3. Unit cost of infrastructure—the price of sensors, processors, additional equipment, power consumption, infrastructure, and required person-hours per vehicle unit.

In practice, a single failure can be classified into one of the following categories: 1. Hardware failure: physical alteration of position or state of circuit components, bugs in the software, etc. Various methods of the final cost (optimal and reliable technical design) can minimize it. 2. Uncertainty: the autopilot, when making an assessment, thinks that something went wrong but cannot understand what exactly, or can, but is not able to make an unambiguous decision. It's an unfortunate but tolerable failure requiring a security mechanism scenario. 3. Wrong decision: the most dangerous type of failure, that can easily lead to an emergency situation.

Approaches to developing an improved autopilot may include HD map and pure vision. Regarding the HD Map approach, probably, everyone who was somehow interested in the topic of drones has ever heard a similar phrase: “a drone must know where it is, what is around it . . . ”, and there, most likely, it was mentioned that “you need to know where it is necessarily with near-centimeter accuracy. So, “knowing where it is” means just positioning in the HD map. HD map is a virtual 3D space tied to a certain real-world area. It consists of point clouds taken by LIDARs and infrastructure objects marked inside these clouds (roads, lanes, markings, traffic lights, etc.). This feature is outstanding because it makes navigating and tracking surrounding objects on such a map relatively simple. This approach is usually associated with driving on rails. Additionally, the elements of the classical approach are perception, planning, and control, which are usually discussed at any conference of any autopilot developer. There is an established opinion that high-precision localization in HD maps and perception built on sensor fusion makes it possible to implement an autopilot for driverless operation.

By contrast, the pure vision approach autopilot generates decisions in the same manner as a human. The minimum set of the required equipment is primitive: cameras and a processor, which serve as the eyes and brain of a vehicle. Cameras provide the richest source of information about the world around us. The primary problem (if not the only one) is that it is quite challenging to develop a computer system capable of making an adequate assessment of visual information. Most industry participants believe that due to the lack of sensors with distance measurement (lidar, radar) and the lack of high-precision localization in the short term, it is exceptionally tough, if not impossible, to reach the 5th level of autonomy.

The classical approach has an undeniable advantage: most of its sensing is conducted via LIDAR.

With remarkably high accuracy, LIDAR can produce easily processable information about the distance to the nearest physical obstacles and 3D coordinates of a set of points. Combined dots form relatively easy to process clouds and make solving a number of non-trivial problems, most notably object detection, less difficult. The second task of the LIDAR is localization in the HD map, which leads to the major problem—scaling. The autopilot, which operates according to the classical approach, must possess a built HD map to function and navigate successfully (a vehicle can only travel within locations that had been digitized first). It is easy to assume that the cost of scaling will be linear at best. At worst, it will rise exponentially with increasing coverage area.

The exploitation of HD maps includes a centimeter positioning accuracy coupled with millisecond level synchronization of all sensors. Companies like Waymo and Toyota justify that with a safety factor: at a speed of 100 kilometers per hour a car travels 2.7 meters in 100 milliseconds; hence a millisecond synchronization and accurate localization are needed. However, there are critically few cases in which millisecond synchronization and centimeter localization play a key factor—mainly, the high inertia of a car system and the laws of physics nullify the pursuit of milliseconds. Additionally, most car accidents occur due to the wrong driver's assessment-decision and corrupted reaction time (fatigue state or distractions), and not due to the lack of high-level sensors. The costs of implementation and technical support of LIDARs are too high. Thus, from a practical point of view, the trade-off turns out to be too unprofitable.

The classical approach of HD maps is relatively simple, practically non-scalable, and expensive. It requires a complex infrastructure, but the stack of its work is quite understandable, implementable, and is based on technologies fully mastered by mankind. In the case of pure vision, there is an elegant concept of the solution and a non-trivial task that no one has completed yet.

Accordingly, a need arises for autonomous systems with improved autonomy so as to operate largely, or even completely, autonomously.

### SUMMARY

Embodiments of the present systems and methods may provide techniques for an alternative and innovative approach to autonomous systems. Embodiments may emphasize two already existing senses: video and audio signals, since vehicle operators rely on their eyes and ears to operate a vehicle. Conventional systems may utilize cameras, but such systems do not utilize audio signals. Embodiments may detect the other vehicles just by sound alone after filtering noise, such as the sound of wind, surrounding environment, and vehicle's engine. Embodiments may combine the filtered audio signal with the visual filtered signal to become as effective as LIDAR and RADAR applications without existing drawbacks of these technologies.

For example, Unmanned Aircraft Systems (UAS) drones may provide advance collection of imaging and Vision data. This data may be used as feedback into the vehicle system allowing advance awareness and decision support for automated guidance and collision avoidance.

For example, in an embodiment, a mobile system may comprise a vehicle, vessel, or aircraft comprising a plurality of video sensors, and a plurality of audial sensors, adapted to obtain information about surroundings of the vehicle, vessel, or aircraft and to transmit video and audial data representing the information about surroundings of the vehicle, vessel, or aircraft, and at least one computer system adapted to receive the video and audial data from the plurality of sensors, perform fusion of the received data to generate information representing the surroundings of the vehicle, vessel, or aircraft, and to use the generated information to provide autonomous functioning of the vehicle, vessel, or aircraft.

In embodiments, the system may further comprise digital signal processing circuitry adapted to filter the video and audial data to reduce noise. The computer system may be further adapted to perform machine learning to generate improved tuning parameters for the digital signal processing circuitry adapted to filter the video and audial data. The generated information representing the surroundings of the vehicle, vessel, or aircraft may be displayed to a human operator of the vehicle, vessel, or aircraft to provide automation assistance. The vehicle, vessel, or aircraft may be a military or tactical vehicle and the generated information representing the surroundings of the vehicle, vessel, or aircraft is communicated with a human vehicle commander regarding when normal operations of a vehicle escalate into a combat response. The generated information representing the surroundings of the vehicle, vessel, or aircraft may be used to provide full automation of the vehicle, vessel, or aircraft.

In an embodiment, a method of implementing a mobile system may comprise receiving data from a plurality of video sensors, and a plurality of audial sensors, adapted to obtain information about surroundings of the vehicle, vessel, or aircraft and to transmit video and audial data representing the information about surroundings of the vehicle, vessel, or aircraft, at at least one computer system comprising a processor, memory accessible by the processor, and computer program instructions stored in the memory and executable by the processor, and at the computer system, receiving the video and audial data from the plurality of sensors, performing fusion of the received data to generate information representing the surroundings of the vehicle, vessel, or aircraft, and using the generated information to provide autonomous functioning of the vehicle, vessel, or aircraft.

In an embodiment, a computer program product may comprise a non-transitory computer readable storage having program instructions embodied therewith, the program instructions executable by a computer comprising a processor, memory accessible by the processor, and computer program instructions stored in the memory and executable by the processor, to cause the computer to perform a method that may comprise receiving data from a plurality of video sensors, and a plurality of audial sensors, adapted to obtain information about surroundings of the vehicle, vessel, or aircraft and to transmit video and audial data representing the information about surroundings of the vehicle, vessel, or aircraft, at least one computer system comprising a processor, memory accessible by the processor, and computer program instructions stored in the memory and executable by the processor, and at the computer system, receiving the video and audial data from the plurality of sensors, performing fusion of the received data to generate information representing the surroundings of the vehicle, vessel, or aircraft, and using the generated information to provide autonomous functioning of the vehicle, vessel, or aircraft.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary block diagram of a system in which embodiments of the present systems and methods may be implemented.

FIG. 2 is an exemplary block diagram of a system, which may be included in one or more self-aware mobile systems according to embodiments of the present systems and methods.

FIG. 3 is an example of operation of embodiments of the present systems and methods.

FIG. 4 is an exemplary diagram of the SAE standard levels of automation for vehicles according to embodiments of the present systems and methods.

FIG. 5 is an exemplary diagram of the natural and machine intelligence underpinning autonomous systems may be inductively generated through data, information, and knowledge according to embodiments of the present systems and methods.

FIG. 6 is an exemplary illustration of A hierarchical intelligence model (HIM) created for identifying the levels of intelligence and their difficulty for implementation in computational intelligence based on the abstract intelligence (al) theory according to embodiments of the present systems and methods.

FIG. 7 is an exemplary diagram of Autonomous Systems implementing nondeterministic, context-dependent, and adaptive behaviors according to embodiments of the present systems and methods.

FIG. 8 is an exemplary block diagram of a computer system, in which processes involved in the embodiments described herein may be implemented.

FIG. 9 is an exemplary diagram of a self-driving vehicle according to embodiments of the present systems and methods.

FIG. 10 is an exemplary diagram of the operation of a RADAR system according to embodiments of the present systems and methods.

FIG. 11 is an exemplary diagram of applications of RADAR to autonomous vehicles according to embodiments of the present systems and methods.

FIG. 12 is an exemplary diagram exemplary LIDAR system according to embodiments of the present systems and methods.

FIG. 13 is an exemplary diagram of applications of RADAR, cameras, and LIDAR to autonomous vehicles according to embodiments of the present systems and methods.

FIG. 14 is an exemplary diagram of RADAR/LIDAR fusion according to embodiments of the present systems and methods.

FIG. 15 is an exemplary diagram of a system providing RADAR/LIDAR fusion according to embodiments of the present systems and methods.

FIG. 16 is an exemplary diagram of a system providing RADAR/LIDAR fusion according to embodiments of the present systems and methods.

FIG. 17 is an exemplary diagram of an audio/video system for autonomous vehicles according to embodiments of the present systems and methods.

FIG. 18 is an exemplary diagram of an audio/video sensor unit for autonomous vehicles according to embodiments of the present systems and methods.

FIG. 19 is an exemplary diagram of an interface between sensor units and master processor according to embodiments of the present systems and methods.

FIG. 20 is an exemplary diagram of sensor unit according to embodiments of the present systems and methods.

FIG. 21 is an exemplary diagram of a delay module of a sensor unit according to embodiments of the present systems and methods.

FIG. 22 is an exemplary diagram of a configuration module of a sensor unit according to embodiments of the present systems and methods.

FIG. 23 is an exemplary diagram of a memory module of a sensor unit according to embodiments of the present systems and methods.

FIG. 24 is an exemplary diagram of a data format of a sensor unit according to embodiments of the present systems and methods.

FIG. 25 is an exemplary diagram of a camera read parameter sub-module of a sensor unit according to embodiments of the present systems and methods.

FIG. 26 is an exemplary diagram of a formatted transmission sub-module of a sensor unit according to embodiments of the present systems and methods.

FIG. 27 is an exemplary diagram of a format for transmission of data from the formatted transmission sub-module of a sensor unit according to embodiments of the present systems and methods.

FIG. 28 is an exemplary data diagram of state machine operation for transmission of data from the formatted transmission sub-module of a sensor unit according to embodiments of the present systems and methods.

FIG. 29 is an exemplary diagram of a master sub-module of a sensor unit according to embodiments of the present systems and methods.

FIG. 30 is an exemplary data diagram of state machine operation for transmission of data from the formatted transmission sub-module of a sensor unit according to embodiments of the present systems and methods.

FIG. 31 is an exemplary data diagram of operation of a median filter of a sensor unit according to embodiments of the present systems and methods.

FIG. 32 is an exemplary illustration of differences between filtered and unfiltered images according to embodiments of the present systems and methods.

FIG. 33 is an exemplary diagram of clock circuitry of a sensor unit according to embodiments of the present systems and methods.

FIG. 34 is an exemplary diagram of a module of clock circuitry of a sensor unit according to embodiments of the present systems and methods.

FIG. 35 is an exemplary diagram of a phase-locked loop module of clock circuitry of a sensor unit according to embodiments of the present systems and methods.

FIG. 36 is an exemplary diagram of an audio system of a sensor unit according to embodiments of the present systems and methods.

FIG. 37 is an exemplary diagram of an ADC receive/transmit sub-module of a sensor unit according to embodiments of the present systems and methods.

FIG. 38 is an exemplary data diagram of operation of a transmission protocol of a sensor unit according to embodiments of the present systems and methods.

FIG. 39 is an exemplary diagram of a filter sub-module of a sensor unit according to embodiments of the present systems and methods.

FIG. 40 is an exemplary data diagram of operation of a filter of a sensor unit according to embodiments of the present systems and methods.

FIG. 41 is an exemplary diagram of a filter transfer function of a sensor unit according to embodiments of the present systems and methods.

FIG. 42 is an exemplary diagram of input and output signals of a filter of a sensor unit according to embodiments of the present systems and methods.

FIG. 43 is an exemplary diagram of circuitry for loading configuration of circuitry in an FPGA of a sensor unit according to embodiments of the present systems and methods.

### DETAILED DESCRIPTION

Embodiments of the present systems and methods may provide techniques for autonomous systems with improved autonomy so as to operate largely, or even completely, autonomously. Embodiments may utilize computational input and output on the structural and behavioral properties that constitute the intelligence power of human autonomous systems. Embodiments may utilize vision and image and visual processing at the core as input. Embodiments may utilize collected vision data as the intelligence aggregates from reflexive, imperative, adaptive elements to manage the intelligence for an autonomous self-driving system. Embodiments may utilize a Hierarchical Intelligence Model (HIM) to elaborate the evolution of human and system intelligence as an inductive process used in car and vehicle systems. Embodiments may utilize a set of properties used for system autonomy that is formally analyzed and used towards a wide range of autonomous system applications in computational intelligence and systems engineering.

Embodiments of the present techniques may provide an alternative and innovative approach to autonomous vehicles, such as cars. The core principle behind the approach is emphasis on two already existing senses: vision and audial signals. Since drivers rely on their eyes and ears to navigate the car, embodiments may utilize the principle. Even though using cameras is a well-existing method and currently practiced by a few companies, the emphasis on audial signal has not been done. Embodiments may provide detection of the approaching cars just by sound alone via filtering out of the sound of wind, surrounding environment, and vehicle's engine. Combining it with the visual filtered signal, embodiments may become as effective as LIDAR and RADAR applications without existing drawbacks of these technologies.

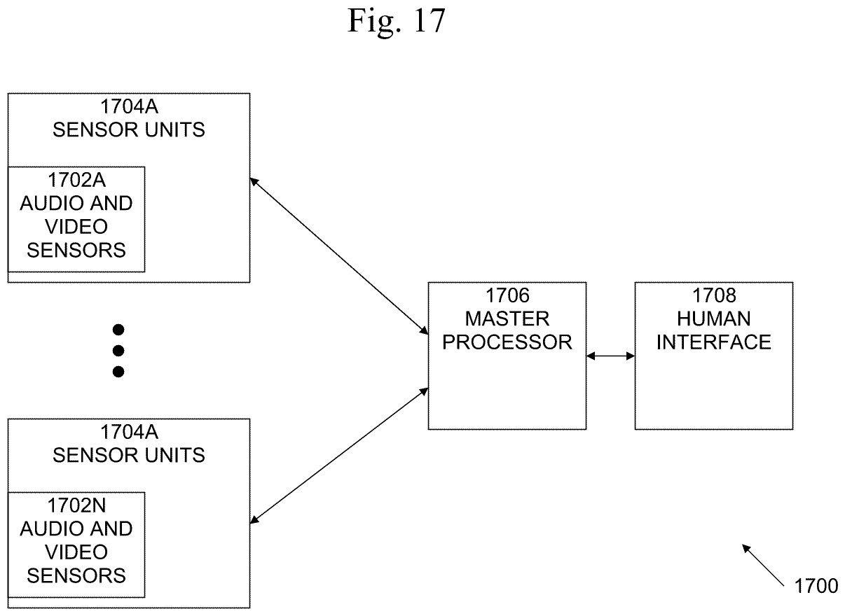

An exemplary embodiment of an audio/video system 1700 for autonomous vehicles is shown in FIG. 17. In this example, audio/video system 1700 may include a plurality of audio and video sensors 1702A-N, which may be included in sensor units 1704A-N, master processor 1706, and human interface 1708. Each sensor unit 1704A-N may include audio and video sensors 1702A-N, which may include one or more cameras, one or more audio detection devices, and circuitry, such as an FPGA, which is responsible for initial filtering of the audio and video data. Each sensor unit 1704A-N may send the filtered data to the master processor 1706, which may be driven by AI computational power, and which may provide further filtering, perform object detection, recognition, and extraction of the additional data (such as velocity of approaching cars). Further, master processor 1706 may use machine learning to generate improved tuning parameters for the filtering performed by sensor units 1704A-N. Such improved tuning parameters may be transmitted from master processor 1706 to sensor units 1704A-N, and may provide improved filtering performance. Depending on the obtained information, master processor 1706 can adapt its “eyes” and “ears” to obtain more effective information that reduces the effect of weather conditions, time of the day, surrounding environment, etc., on the data. Master processor 1706 may perform the improved navigation and control of the vehicle upon receiving sufficient training.

Human vision is the main component of the driving process. Using eyes, human brain receives around 24 images per second. Instead of using an expensive and bulky LIDAR technology, embodiments may exploit a standard camera with more or less the same recording frequency and to combine it with advanced DSP techniques and AI algorithms.

An exemplary sensor unit 1704A-N may include, for example, one or more ADMP421 audio recording devices, one or more OV7670 video recording devices, and a Cyclone 10LP FPGA. The FPGA Cyclone II, along with the video and audio recording devices, may be used to detect visual and audial objects. Each sensor unit 1704A-N may be placed behind a semi-transparent mirror for protection from the elements and to hide the sensors. The FPGA may provide configurable computational capabilities.

For example, the CMOS OV7670 camera module is a CMOS image sensor with operational low voltage, high sensitivity, and small size. The operation of OV7670 is provided by controlling ADCs, timing generators, embedded DSP submodule for a specific type of image processing, test pattern generators, and strobe flash control. The image processing functions include gamma, image exposure control, color saturation control, white balance, hue control. Upon capturing the image, the raw data can undergo digital signal processing including digital anti-noise filtering techniques. The preprocessing configuration of OV7670 is set up via SCCB interface. Overall, the features of this camera make it a decent small-sized image recorder: high sensitivity for low light operations, automatic adjustment of enhancing range of edge, saturation level, and de-noise range, scaling support, Automatic image control functions, such as AEC (automatic exposure control), AGC (automatic gain control), AWB (automatic white balance), ABF (automatic band filter), and ABLF (automatic black-level calibration), SNR 46 dB at 30 frames per second, 640×480 resolution, 60 mW power consumption, support of various image sizes and different formats such as YUV(4:2:2), YCbrCr(4:2:2), and RGB (RGB 4:2:2, RGV565/555/444) The functionality and noise quality characteristics of image recorder coupled with the size and power parameters make it a decent choice for applications such as a side-camera of a vehicle.

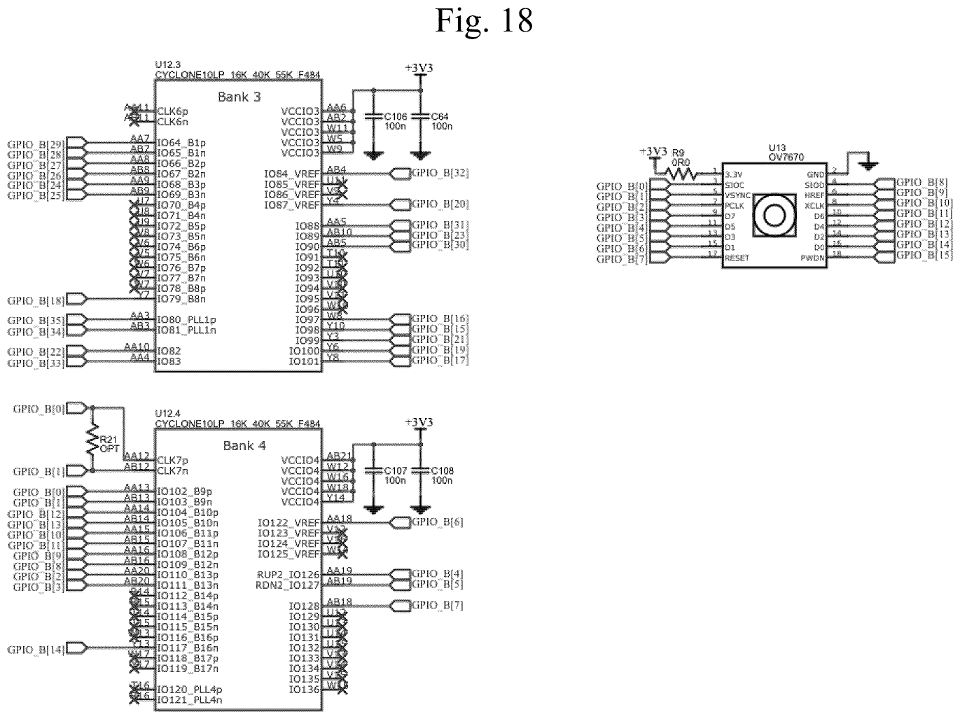

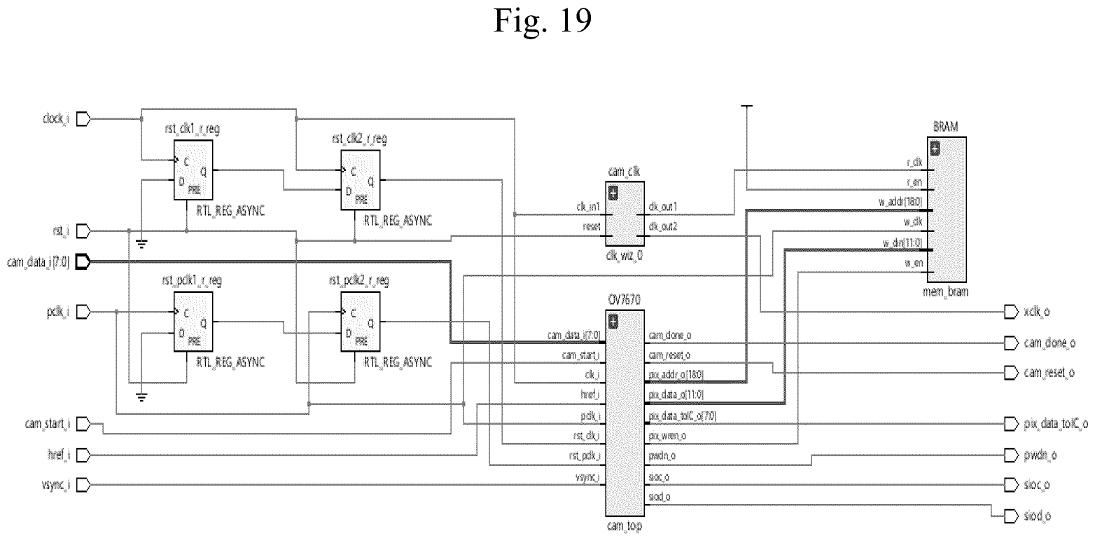

Cyclone 10LP provides OV7670 with a 24 MHz clock source and receives the data via 8-bit data bus, as shown in FIG. 18. The SIOC and SIOD pins are used to configure the parameters of OV7670. The data capturing interface consists of synchronization signals via HREF and VSYNC, and internally generated PLL clock PLCK to latch the 8-bit data to a clock source, both provided to Cyclone 10LP. An exemplary interface of the OV7670 and master processor is shown in FIG. 19. Cyclone 10 LP receives following inputs: clocking source, camera synchronization signals and PLL generated clock, as well as camera data bits and two external signals from master processor. The latter are used when for master processor to command Cyclone 10 LP to either reconfigure OV7670 with updated parameters (rst_i), or to initialize OV7670 interfacing procedure (cam_start_i). Internal clock IP core was implemented to receive external 100 MHz crystal oscillator clock input and generate 24 MHz output clock as a OV7670 system clock and 25 MHz clock to perform reading from Block RAM memory. Received inputs are used to trigger the operation of OV7670 and BRAM modules, performance of which is discussed later in this section. Cyclone 10 LP outputs system clock, power-down and reset commands for OV7670, SCCB interface clock (sioc_o) and data (siod_o) for OV7670 configuration, as well as 8-bit parallel data output of recorded frame and indicator of completion of frame recording to master processor.

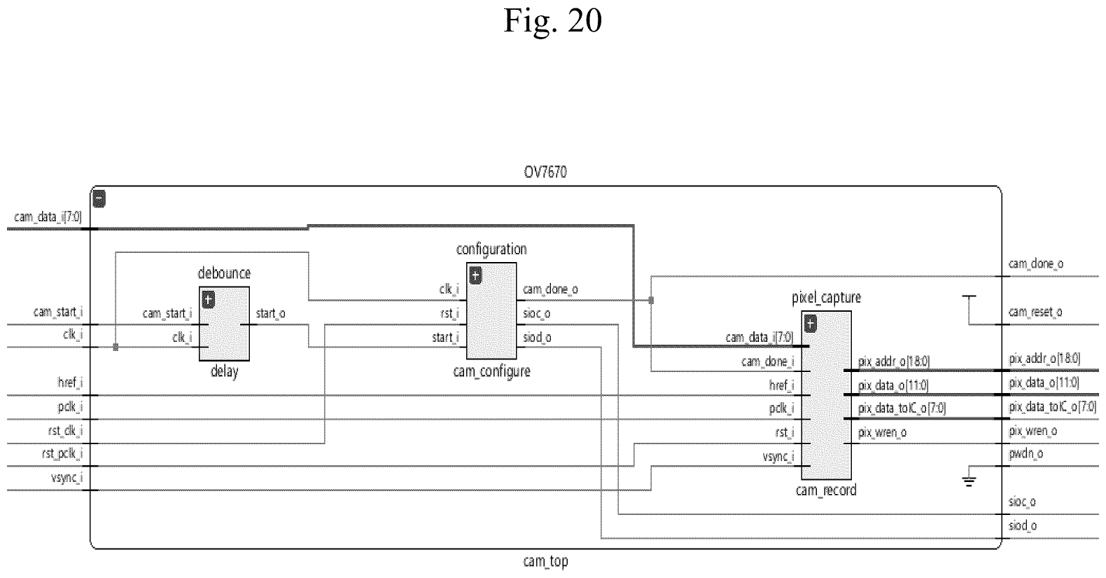

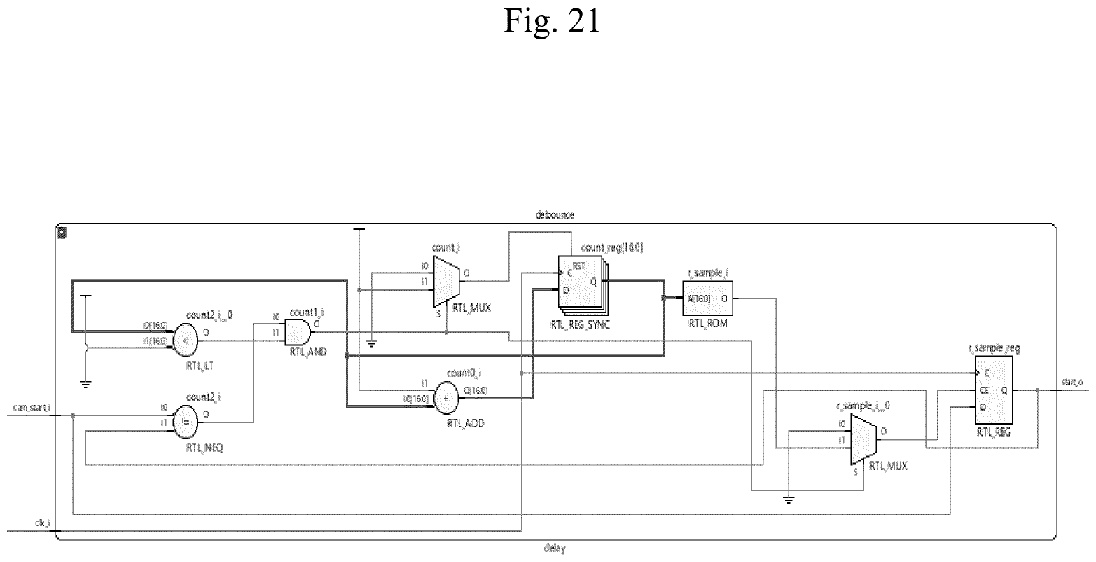

The OV7670 module, shown in FIG. 20, consists of three lower-level modules: delay or debounce, cam_configure, and cam_record. This module is responsible for integrating the delay, if needed, between the command to start OV7670 operation and actual start, configuration of OV7670 setting by uploading specific values of registers to OV7670 registers, and capturing, latching, storing and sending the data to master processor via SPI protocol. The delay module, shown in FIG. 21, works on the following principle. The value of the delay is pre-installed to be 240 microseconds (which can be varied). Upon receiving the signal from master processor to start interfacing with OV7670 (cam_start_i), the counter increments by 1 at each positive edge of 100 MHz input clock. When the value of counter reaches the pre-installed numerical value of delay, delay outputs a start signal to cam_configure module.

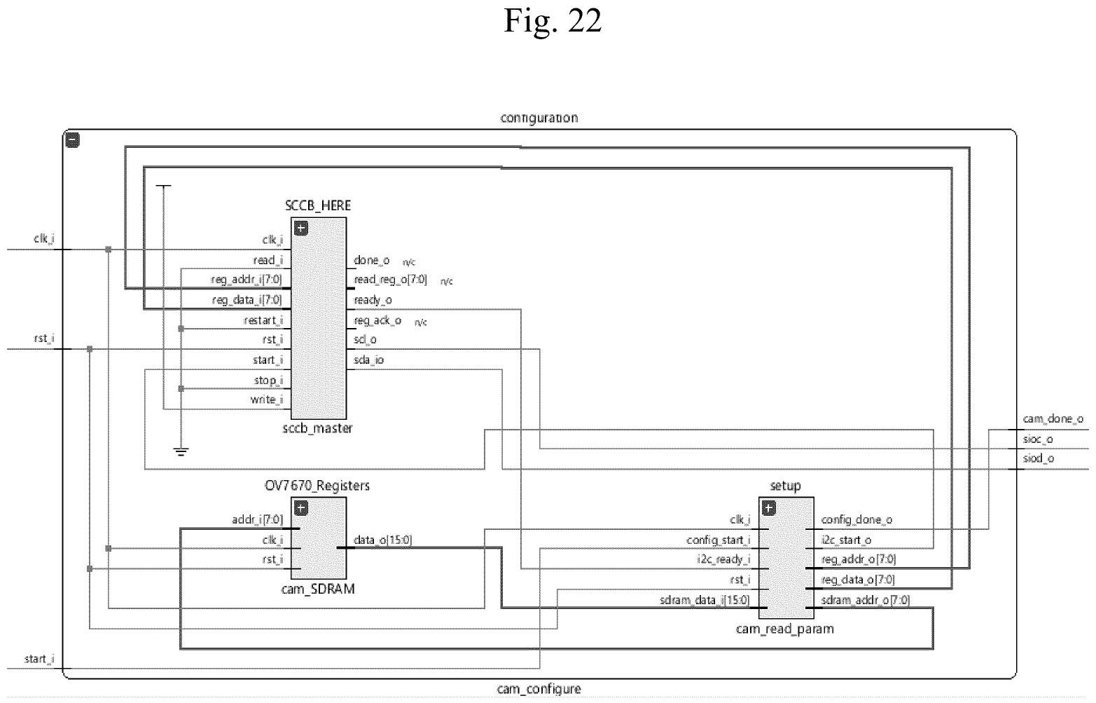

The output starting signal, as well as 100 MHz clock and global reset serve as inputs to cam_configure module, shown in FIG. 22. The purpose of this module is to execute a parameter configuration of OV7670 (via sioc_o and siod_o) and generate an indicator (cam_done_o) when the uploading the parameters is completed. This module consists of three sub-modules: cam_SDRAM, cam_read_param, and sccb_master, each of them performing an individual function towards the main purpose of cam_configure module.

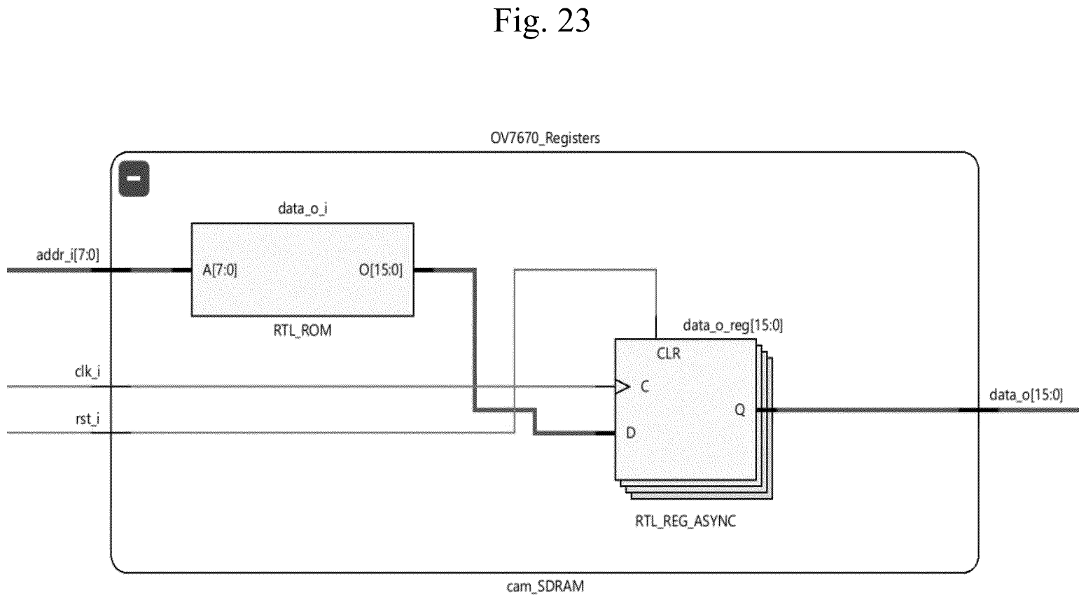

The SDRAM memory module cam_SDRAM, shown in FIG. 23, consists of 77 16-bit data registers with initial pre-set values of each register. Each register carries information of OV7670 register address and data, according to the OV7670 data sheet. The values of the registers can re-written by master processor immediately upon the reset procedure, while the delay module is running, and are addressed by cam_read_param module 8-bit via addr_i input. When addressed, the value of addr_i is applied to designed multiplexers, and on the following positive edge of 100 MHz clock, one of the 77 16-bit data registers is latched onto the output dateline data_o. Hence, the information about OV7670 register's address and data goes as 16-bit input to the setup cam_read_param module.

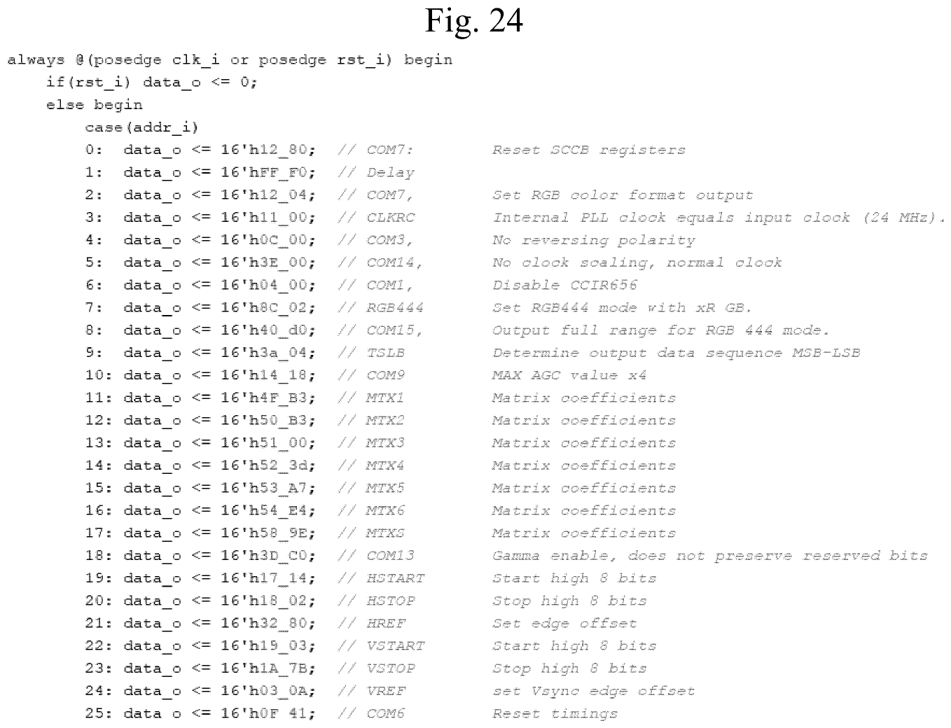

The pre-defined registers' values determine the performance of OV7670, including the clocking, data format, DSP techniques applied, etc. For the purpose of serving as an informational brochure, there is no detailed analysis on the OB7670 data sheet registers written. The 24 MHz clock supplied from Cyclone 10 LP generates an internal 24 MHz clock within OV7670, as dictated by the value of CLKRC register. The data format is chosen to be RGB 444 mode, as stated by the contents of RGB444 register, as shown in FIG. 24.

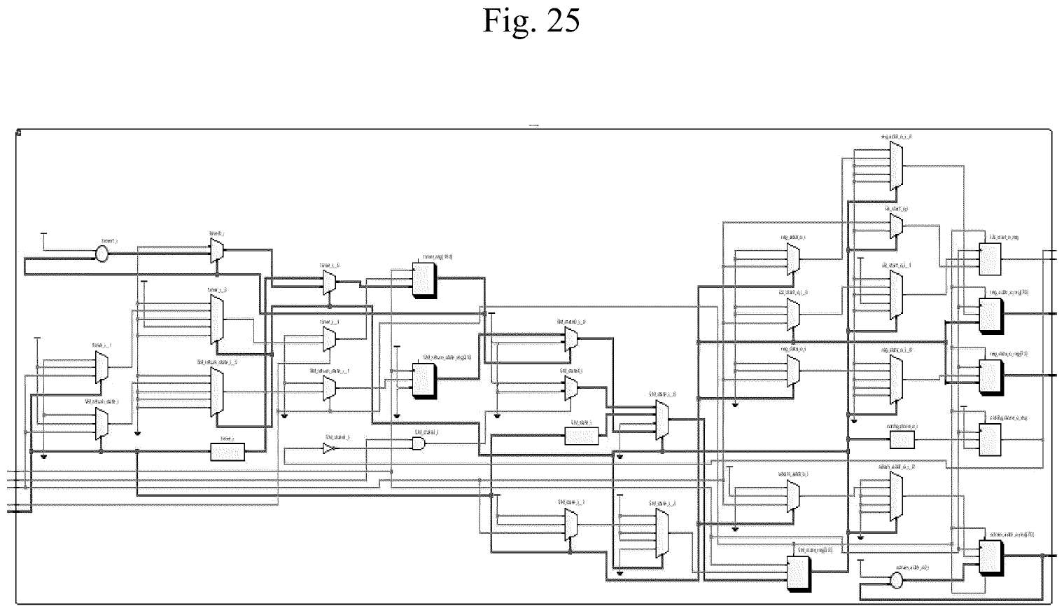

The purpose of cam_read_param sub-module, shown in FIG. 25, is to address all the registers' values of SDRAM upon receiving the starting signal from the delay module and sending them in two parallel packets—8-bit register address and 8-bit register data—to sccb_master sub-module. The designed architecture uses a state machine with 3 corresponding states: IDLE, SEND, and DONE. The IDLE state corresponds for stalling position awaiting for the starting signal from the delay module. Immediately after receiving the starting signal, the process moves to SEND state. In this state, right after receiving an indicator from sccb_master sub-module that it's ready to perform I2C transmission of configuration 16-bit word, the input data from SDRAM is latched and divided into two 8-bit packets. The two 8-bit packets—the address and the data for a one OV7670 registers—are outputted to the sccb_master sub-module. In the very same time, cam_read_param commands sccb_master sub-module to start the transmission to OV7670 (via i2c_start_o) and the address is incremented by 1. When all the values from SDRAM are retrieved, divided, and outputted to sccb_master sub-module, the process states shifts to DONE and corresponding indicator config_done_o is outputted to sccb_master sub-module.

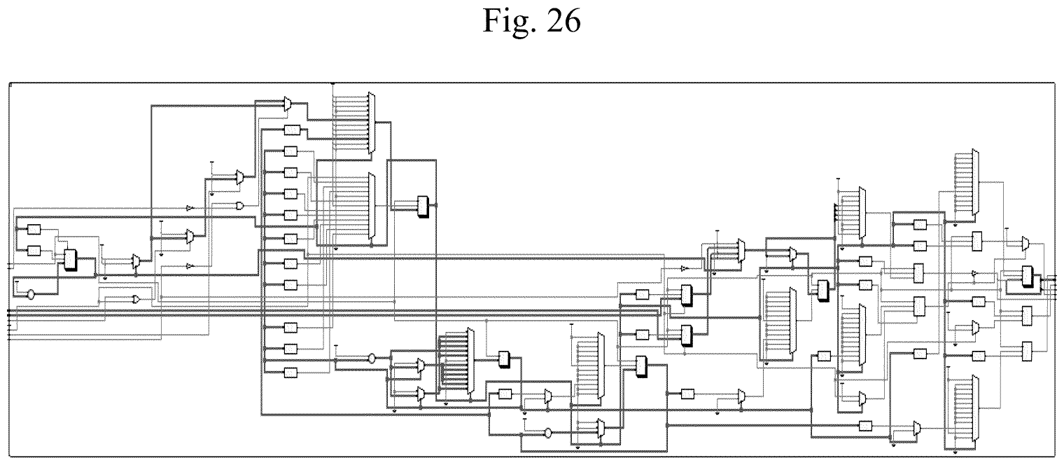

The sccb_master sub-module, shown in FIG. 26, has a purpose to transmit the data to OV7670 in SCCB format to configure the camera module. It receives the two 8-bit data packets (corresponding for the targeted register address and data respectively) as well as the command from cam_read_param submodule to start the transmission and outputs the SCCB format data to OV7670.

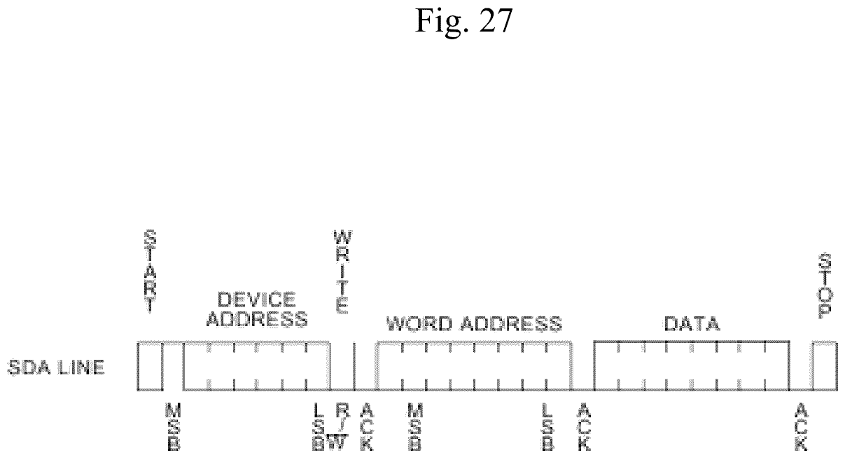

SCCB interface, shown in FIG. 27, is based on three phase write cycle, each cycle carrying a one byte of the information. The first byte is presented by the device address, write/read selection pin, and not don't care bit. The second and third bytes are a register address and data, respectively.

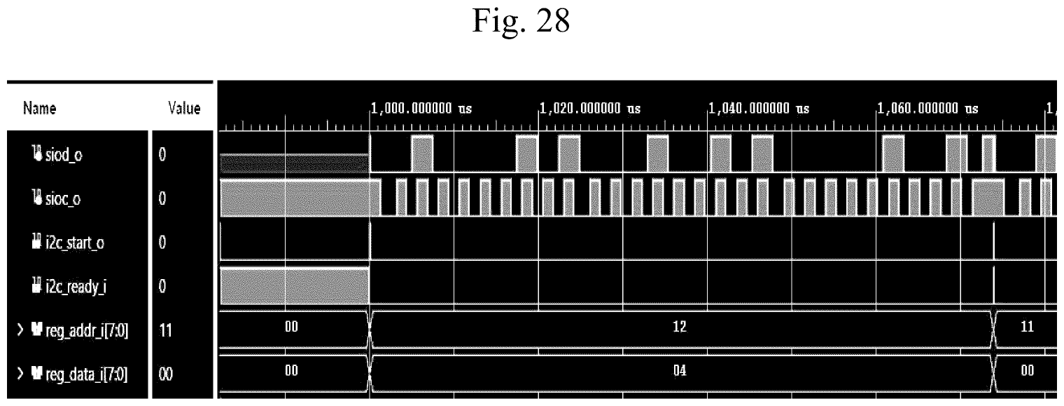

The state machine is designed to continuously perform three cycle write procedure, as shown in FIG. 28, until all data from SDRAM has been latched onto the serial data output siod_o. Immediately upon receiving the output i2c_start_o from cam_read_param sub-module, the siod_o output data line is brought from high impedance z-state to logical low state, the sioc_o output configuration clock is brought from logical high to logical low state, and the three-byte data, containing the information on device address, write/read mode, address and data of a given register, is serialized bit by bit onto the siod_o output dateline. When a serialization of three bytes for configuring a given register is completed, the ready_o signal is outputted to the sccb_master sub-module (ready_I2C_i), which addresses cam_SDRAM sub-module, retrieves the 16-bit value for the next register, and provides it to the sccb_master sub-module to repeat listed steps of the state machine right until the last register value from cam_SDRAM module is retrieved and serialized.

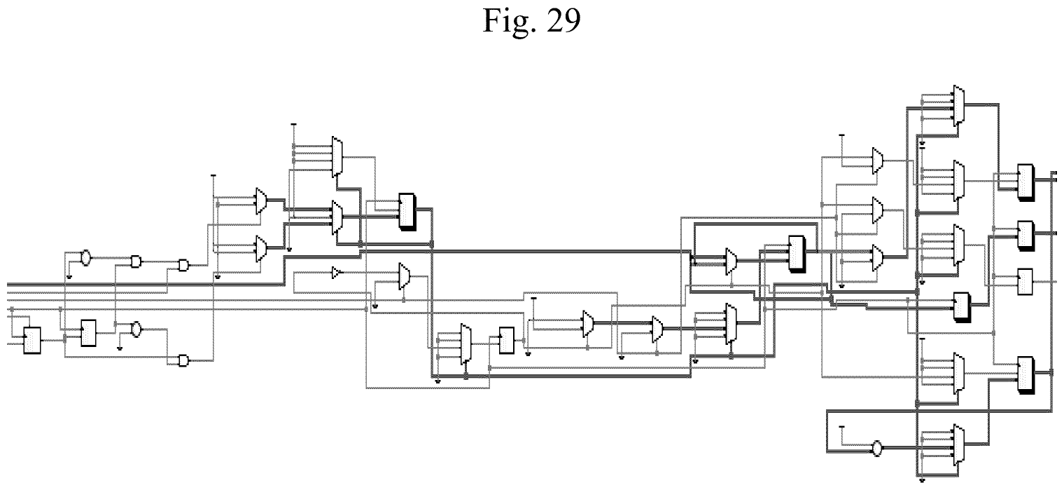

Immediately upon the completion of OV7670 configuration, sccb_master sub-module, as shown in FIG. 29, outputs the cam_done-signal indicator that uploading the registers of OV7670 is finished. This signal serves as an input enabling mechanism to the cam_record module, which is responsible for interfacing with OV7670 image recording functionality and latching the digitized pixel data. The cam_record module receives the 24 MHz clock source pclk_i, generated within OV7670 internal PLL, as well as synchronization inputs href_i and vsync_i, and 8-bit pixel data cam_data_i. The main purpose of this module is to transmit the data to master processor via pix_data_to_IC_o and upload the very same data to the BRAM module, which serves as a back-up mechanism.

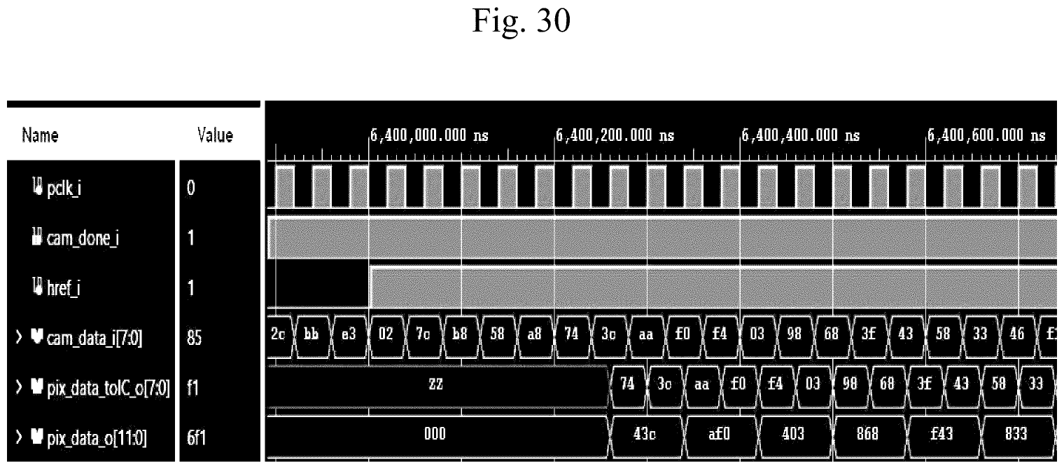

The purpose is executed via the designed state machine. Immediately after sccb_master submodule outputs the cam_done, the data packets are latched to memory module and transmitted to master processor, as shown in FIG. 30. According to the RGB 444 format, each pixel will be presented as two sequential one-byte packets, that are encoding 12-bit pixel value. Four most significant bits of the first byte are don't-care bits, that are to be neglected. The remaining four least significant beats are concatenated to the value of the second byte to form a 12-bit value of pixel. On each negative edge of 24 MHz pclk_i, a byte is uploaded by OV7670 circuitry on the cam_data_i data line. And upon enabling, on each positive edge of 24 MHz pclk_i, a byte is uploaded to SPI output. The data is latched to the BRAM memory on every second positive edge of 24 MHz pclk_i, where two clock cycles are required to concatenate two packets with respect to RGB 444 format. Using href_i, the logic architecture recognizes a first byte, hence ensuring the correct latching and eliminating the possibility of data corruption.

The Cyclone 10LP possesses the same role as in the audial signal detection—initial filtering before transferring the data to the master processor. The necessity of applying the filtering technique is caused by noise throughout the image. The noise has a different nature: camera-induced, signal processing caused, environment-caused. Such noise can be alter the image from the individual pixels as well as local groups of pixels throughout the image, which hinders the successful operation of the object detection algorithms used by master processor. Also, depending on the detection algorithm used, such noise pixel alterations can be “considered” as objects. This is the biggest potential issue for self-driving car, for it will change the course of movement due to incorrect identification of the object. The filtering allows Cyclone 10LP to concentrate on the image difference and neglect the noise, hence transferring to master processor pre-filtered images for the upcoming post-filtering and object recognition and detection driven by AI.

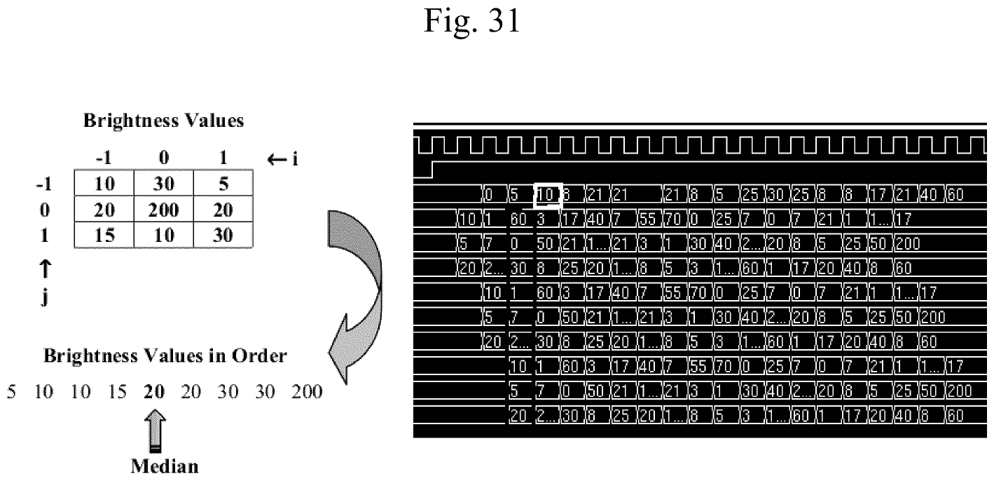

The median filter is implemented within logic architecture of the Cyclone 10LP. The median filter is the most suited for eliminating noise from individual and small local group of pixels noise, which is essential for a safe object detection. The implemented median filter is a sliding window that receives 3×3 pixel data as an input and produces one output. The principle behind operation is sorting the data of 3×3 pixels in ascending order and output the median among them, as shown in FIG. 31.

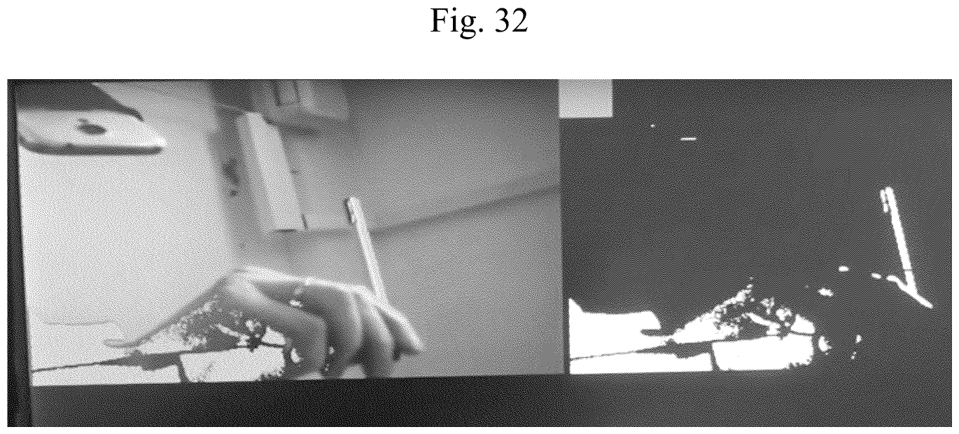

By implementing additional resources of memory module, the image subtraction is executed. The image subtraction is the difference between filtered image and un-filtered image, which shows “active” events happening on the video, as shown in FIG. 32. The main goal of the Cyclone 10LP is to generate this difference and transfer it to master processor via ethernet.

In order to tackle the change of light within 24 hours daily, it's important to provide additional means to the executed event detector. In parallel with the median filter, there is a matrix filter. The matrix filter receives and outputs the same data format as a median filter as well as filters the whole image via the sliding window effect. Yet the key difference is that the matrix filter uses the matrix multiplication, result of which is determined by the constants. The AI-powered master processor determines when it want to «see» more and re-uploads the constants to adapt to increase or decrease of incident light in order to navigate effectively disregarding of the hour.

In order to detect the sound of an approaching vehicles, it is essential to attempt to filter out all possible sounds corresponding for travelling at a random speed through specific surrounding environment. Such constant sounds are presented by sound of an engine, music in a car, surrounding environment, and wind. the sensor board serves as an initial filter based on standard Digital Signal Processing principles, that attenuates all sounds outside of the band of interest. Upon transferring the filtered signal to the master processor, second filtering is to be executed using AI computational powers, that will be discussed in the next section.

Assuming that sound frequency of the wind and engine can range to 10 kHz, Cyclone 10LP is programmed to provide a high-pass filter using Finite Impulse Response (FIR) filter. FIR filter is a filter whose impulse response (or response to any finite length input) is of finite duration, because it settles to zero in finite time. The impulse response of an Nth-order discrete-time FIR filter lasts for N+1 samples, and then settles to zero.

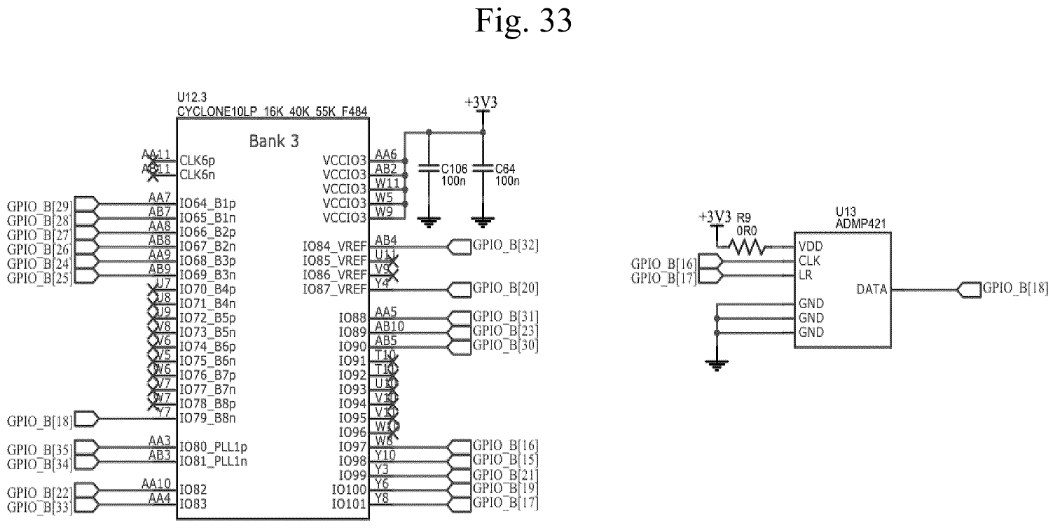

Cyclone 10LP, as shown in FIG. 33, provides three system clocks for CS5343 Audio 24-bit ADC as well as data lines for configuring the parameters and recording sound values. It is important to note that audio transducer can be placed in a flexible manner with respect to sensor board, since it's connected to the ADC via 3.5 mm audio jack.

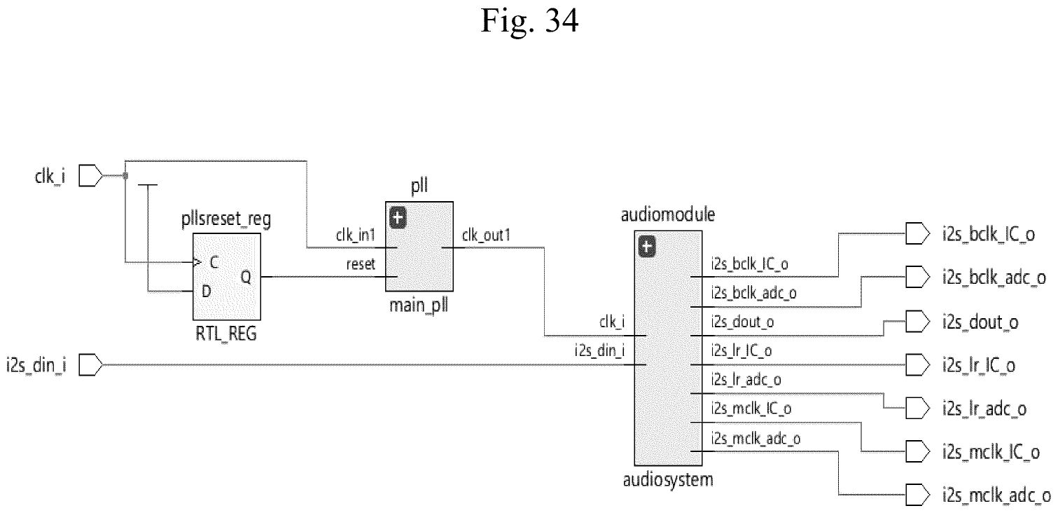

The system architecture of the upper module, shown in FIG. 34, is responsible for interfacing with ADC, receiving, processing, filtering, and transmitting the data to the master processor. It consists of two main modules: main_pll and audiosystem.

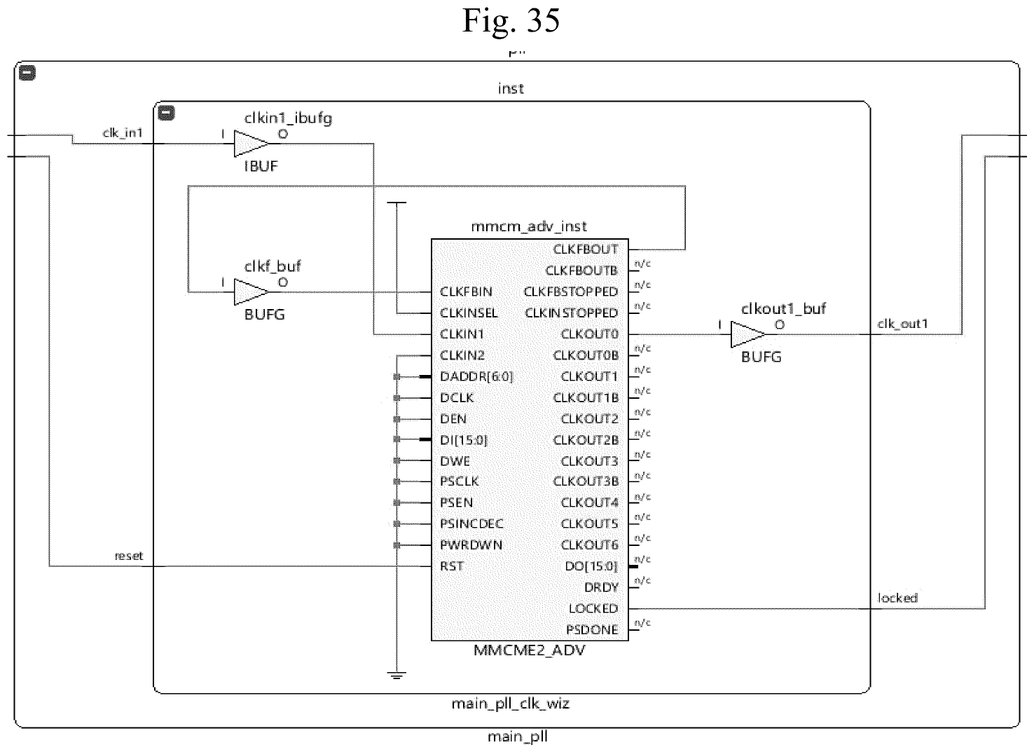

The main_pll includes the implemented clock IP core is shown in FIG. 35. Input 100 MHz clock source from an external crystal oscillator enters the PLL to generate 25 MHz clocking source. The IP core possesses a balanced jitter optimization and the values of peak-to-peak jitter set to be 352.37 picoseconds. The phase alignment mechanism is implemented to bind the output signal to the input signal eliminating potential distortions.

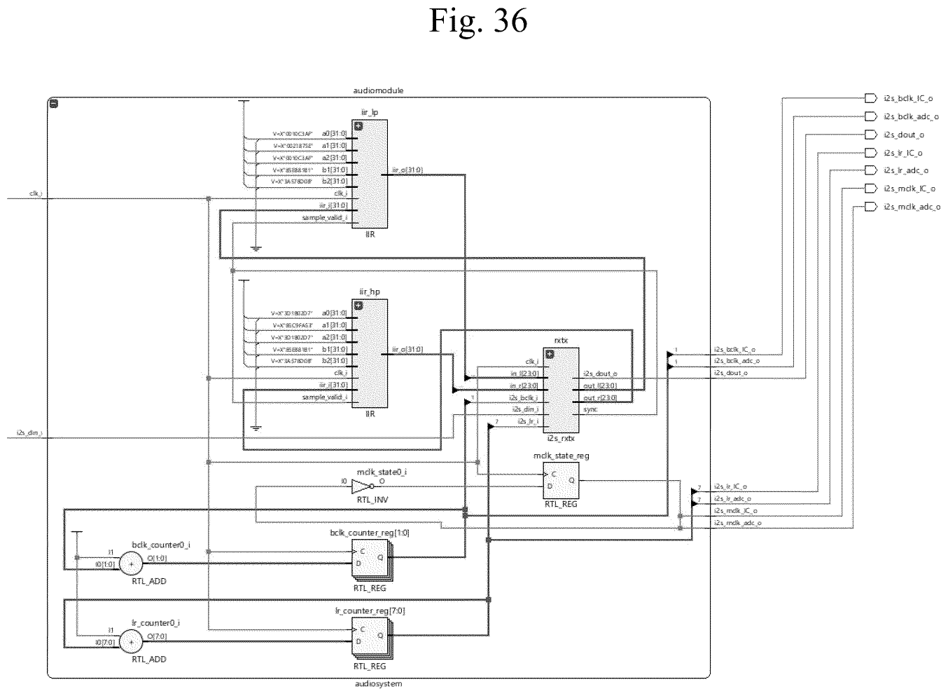

Generated 25 MHz PLL output clock enters the audio system, shown in FIG. 36, as an input clock to the audiosystem module. The audiosystem module's main purpose is to provide the interface with CS5343 Audio 24-bit ADC (designed in rxtx sub-module) and receive, process, filter, and transmit the incoming data of the sound activity from CS5343 to the master processor (IIR sub-module).

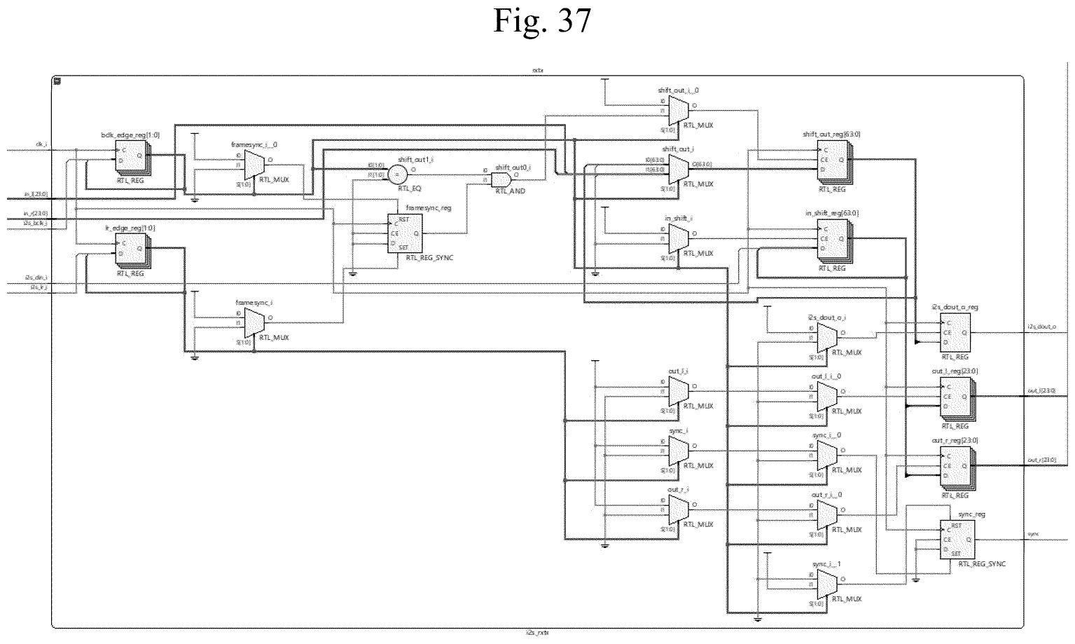

The rxtx sub-module, shown in FIG. 37, is responsible for latching the incoming serial data i2s_din_i from the ADC following the I2S interface standards and forward it to the filtering IR sub-module, where band-stop filtering is applied. At the same time, the rxtx sub-module retrieves the filtered data and outputs it via i2s_dout_o pin to the master processor as well as system, master, and channel clocks.

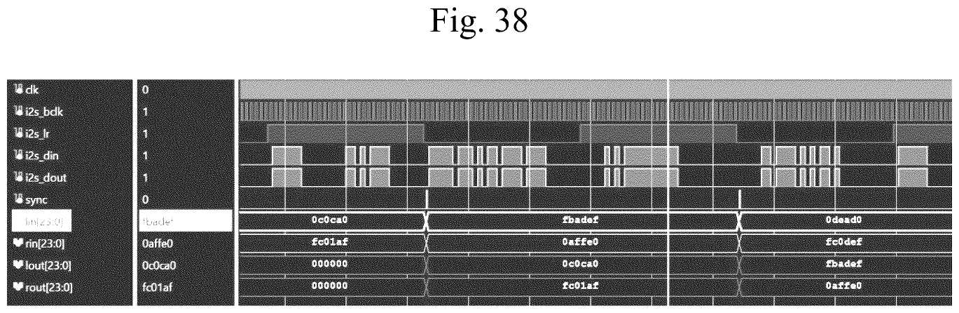

Outputting clock signals with identical characteristics to the requirements of the ADC, as shown in FIG. 38, allows to develop an I2S transmission protocol between Cyclone 10LP and external master processor, where the filtered data is sent to the master processor without any need of storage mechanism, thus preserving the logic resources for potential modifications in filter coefficients.

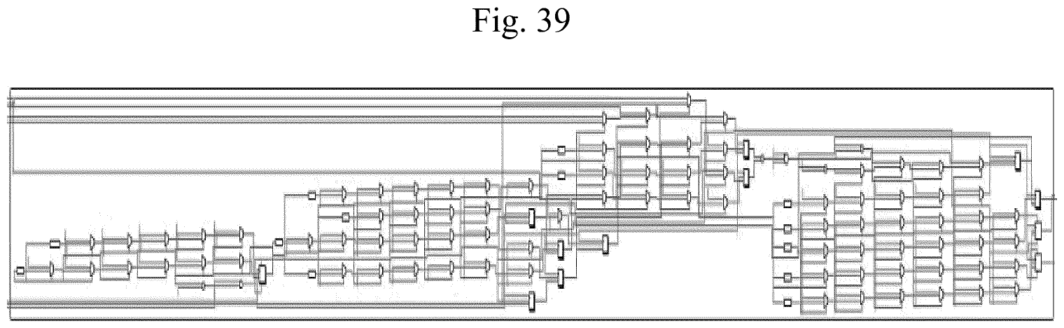

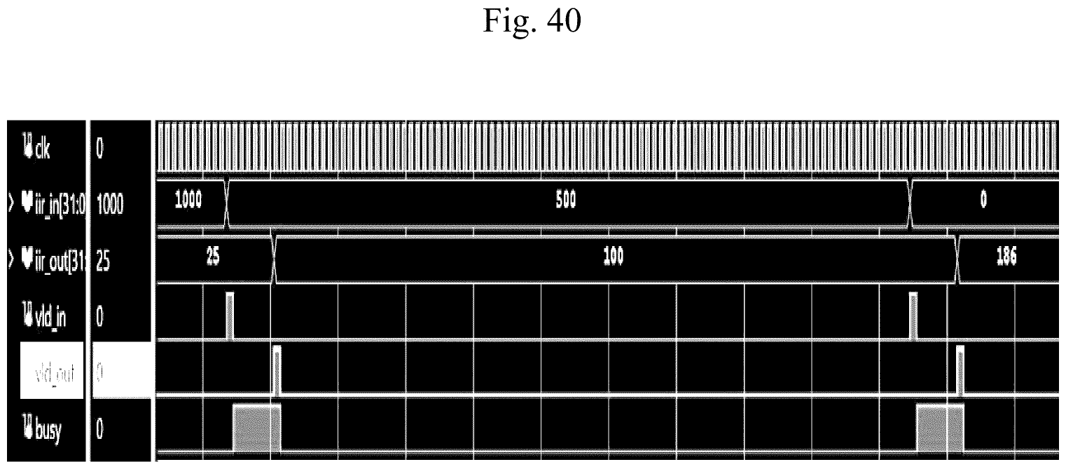

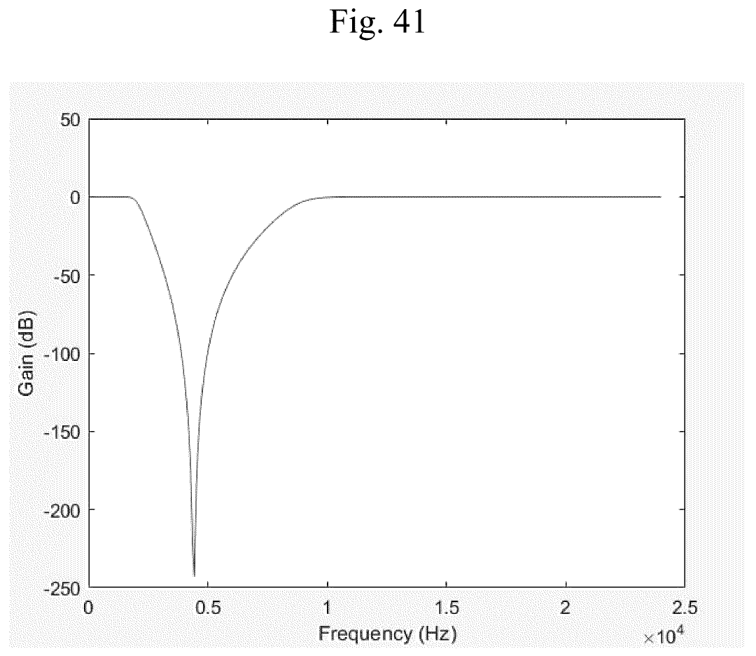

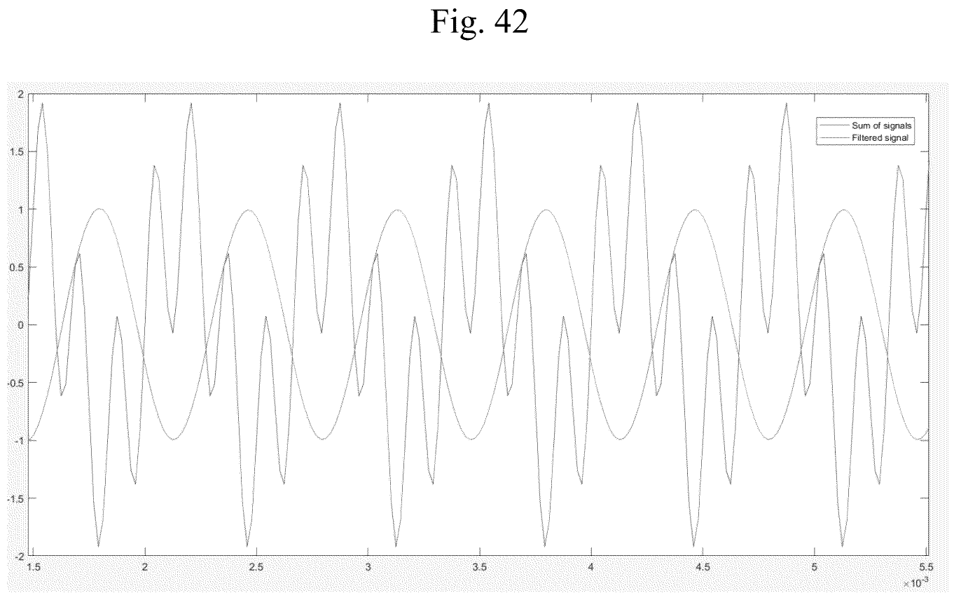

The IIR sub-module, shown in FIG. 39, is presented as a third level Butterworth IIR filter, which receives 25 MHz clock input clk_i, the obtained word from the ADC iir_ir, and values of 5 coefficients α0, α1, α2, b1, and b2, as shown in FIG. 40. The values of the coefficients determine the filter transfer function, shown in FIG. 41, and, accordingly, the filtered output word iir_o. The filtered is designed in a pipeline fashion: instead of developing a high-order filter capable of calculating the weighted output in one clock cycle, rxtx sub-module utilizes two independent third-order filters, where each filters generates the weighted output, as shown in FIG. 42, within 7 cycles of 100 MHz clock input. Such an approach maximizes efficiency/resources ratio and creates a room for the potential modifications. Additionally, the implementation of two parallel IIR filters suits I2S interface, where the data comes in left-right channels format.

The capability to modify the filter coefficients is essential for autonomous filter tuning controlled by the master processor. The rxtx sub-module informs the IR sub-module when the filtering process can start with vld_i signal. Upon receiving this signal, the state machine launches and seven 25 MHz clock cycles after that the filtering weighted calculation is produced following by an output indicator vld_o, which informs the rxtx sub-module.

Two filters, hence, are developed: iir_lp as a low-pass implementation and iir_hp as a high-pass implementation. Initially, passband frequency is set to 2 kHz while stopband frequency is set to 9 kHz, the sampling frequency is set to be 96 kHz.

These filter specifications will be altered by the master processor as an autonomous tuning mechanism, yet the initial parameters are needed. The stopband gap can be widened or narrowed, sharpness of the attenuation slope can also be varied.

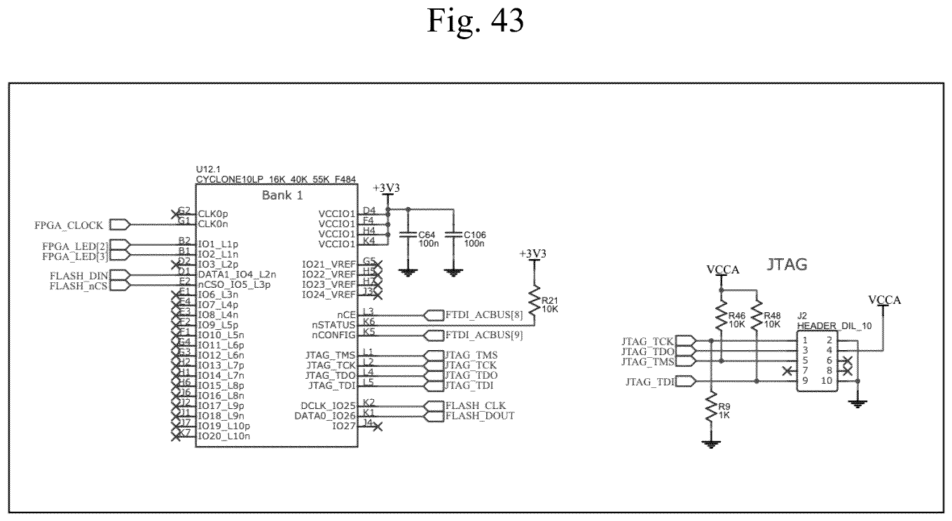

The sensor board transmits signal to the master processor using Ethernet to preserve the maximum speed. Depending on what the master processor “sees” and “hears”, it can tune the audial and visual filtering of each individual sensor board. Hence, disregarding the changes in the average noise/light levels, the sensor boards are always tuned to preserve maximum elimination of the noise and to meet the goal best. The rewriting of sensor board is executed via addressing each individual Cyclone 10LP via JTAG I/O pins, as shown in FIG. 43.

For example, Unmanned Aircraft Systems (UAS) drones may provide advance collection of imaging and Vision data. This data may be used as feedback into the vehicle system allowing advance awareness and decision support for automated guidance and collision avoidance.

As another example, ground-based military or other tactical vehicles may require certain navigational, targeting, and team communication decisions within a forward looking 120 second environment. In embodiments, logic and algorithmic machine learning may inform a vehicle commander of threat patterns based on the environment. The vehicle may implement persistent awareness to generate text or voice data to communicate with a human vehicle commander regarding when normal operations of a vehicle escalate into a combat response. In embodiments, the vehicle may process and analyze data transmitted over RF frequencies and may extract specific data elements that are transmitted over these frequencies. Event monitoring and alerting may include event analysis, visual learning, and role specific decision support. For example, a use-case may include IED hunting.

One of the issues with visual learning may be an overabundance of visual learning, which may cause impairment to team members' cognitive load. In embodiments, areas of current learning may be replaced by the outputs of analytical models. In embodiments, the decision support provided to a commander by our model is intended to support the independent operation of the commander's vehicle alone or may consider automation of action across a multi-vehicle swarm?

Supervised autonomy may be implemented to provide configuration and modification of automated decision making for, for example, a commander, driver and gunner of a vehicle. The system may be updated to include additional candidates for further automation. The autonomy level for a vehicle may likewise be configured for desired autonomy levels.

Examples of military and tactical use-cases may include multi-vehicle swarms, such as a 25-vehicle swarm. Further use cases may include using the generated data to provide combination and coordination with multiple units and levels of units, such as squad and platoon combination and coordination.

Further, communications may be provided using RF-based communications and alternatively or in addition alternatives to RF-based communications, such as forward-deployed private network/5g communications.

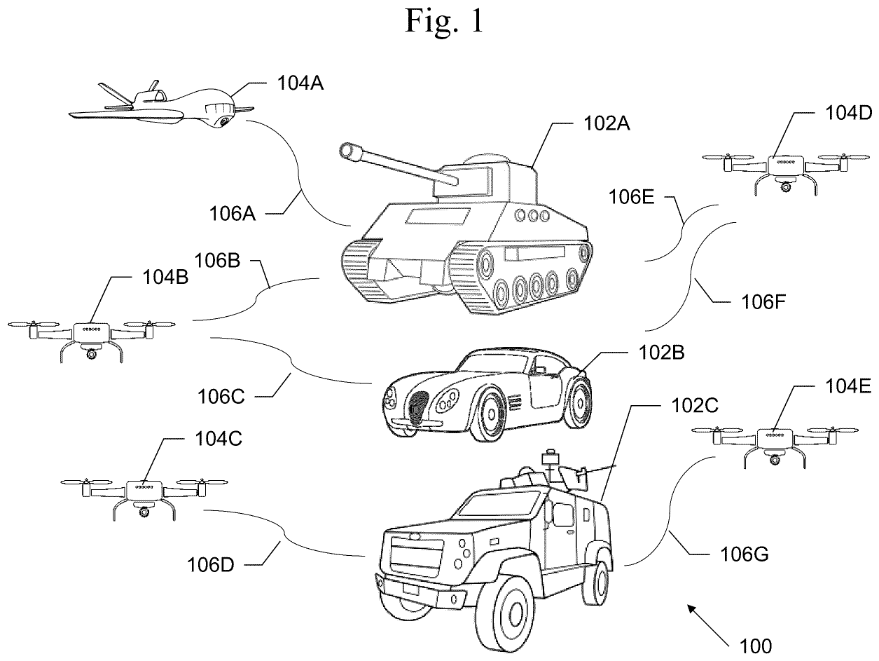

An exemplary block diagram of a system 100, in which embodiments of the present systems and methods may be implemented is shown in FIG. 1. In this example, system 100 may include one or more self-aware mobile systems 102A-C, one or more autonomous sensor platforms 104A-E, and communications links 106A-G. Self-aware mobile systems 102A-C may be any type or configuration of terrestrial, nautical, submarine, or aeronautic vehicle, such as automobiles, trucks, tanks, boats, ships, aircraft, etc. Autonomous sensor platforms 104A-E may include long, medium, and short endurance platforms, such as Unmanned Aerial Vehicles (UAVs), ground drones, etc. For example, long endurance platforms, such as drone 104A may be launched and recovered from external facilities, such as airfields, and controlled by external controllers or autonomous control. Medium and short endurance platforms may likewise be launched and recovered from external facilities, or may be stored in, and launched and recovered from, or in conjunction with self-aware mobile systems 102A-C.

Communications links 106A-G may provide communications between self-aware mobile systems 102A-C and autonomous sensor platforms 104A-E, as well as among individual autonomous sensor platforms 104A-E. Communications links 106A-G are typically wireless links, such as radio frequency (RF) link, optical links, acoustic links, etc. Communications links 106A-G may be encrypted so as to provide secure communications between and among self-aware mobile systems 102A-C and autonomous sensor platforms 104A-E. Using such encryption, communications may be limited to communications between individual self-aware mobile systems 102A-C and autonomous sensor platforms 104A-E, between selected pluralities of self-aware mobile systems 102A-C and autonomous sensor platforms 104A-E, or between all authorized self-aware mobile systems 102A-C and autonomous sensor platforms 104A-E.

Self-aware mobile systems 102A-C and autonomous sensor platforms 104A-E may further be in communication with non-autonomous sensor platforms, such as aircraft, vessels, and other vehicles, and may be in communication with non-terrestrial sensor and/or information providers, such as satellites, for example, surveillance satellites, weather satellites, GPS satellites, etc.

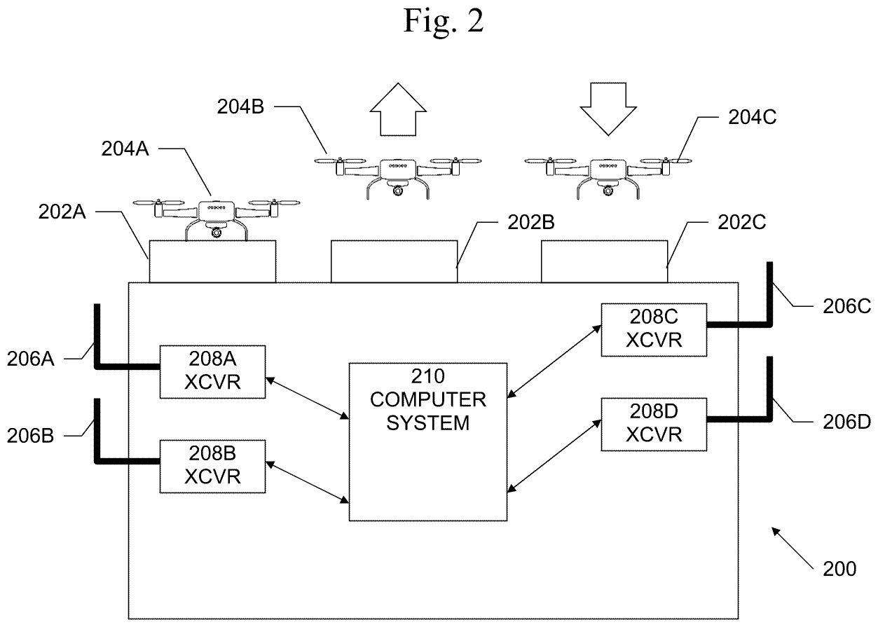

An exemplary block diagram of a system 200, which may be included in one or more self-aware mobile systems 102A-C is shown in FIG. 2. System 200 may include one or more attachment and charging/refueling points 202A-C, which may be used to store and charge/refuel 204A autonomous sensor platforms, launch 204B autonomous sensor platforms, and recover 204C autonomous sensor platforms. System 200 may further include a plurality of antennas 206A-D, which may be connected to transceivers 208A-D, and which together may provide communications of commands, status data, telemetry data, and sensor data with autonomous sensor platforms 204A-C. System 200 may further include computer system 210, which may receive and process status data, telemetry data, and sensor data from autonomous sensor platforms 204A-C, process and forward generate and process status data, telemetry data, and sensor data received from autonomous sensor platforms to other status data, telemetry data, and sensor data from autonomous sensor platforms, generate commands to autonomous sensor platforms 204A-C, and generate intelligent behaviors for one or more self-aware mobile systems using, for example, Hierarchical Intelligence Model (HIM) processing, described below. Likewise, autonomous sensor platforms 204A-C may utilize their own generated status data, telemetry data, and sensor data, status data, telemetry data, and sensor data received from other autonomous sensor platforms, and processed status data, telemetry data, and sensor data, and commands received from one or more self-aware mobile systems and may generate intelligent behaviors for itself using, for example, HIM processing, described below.

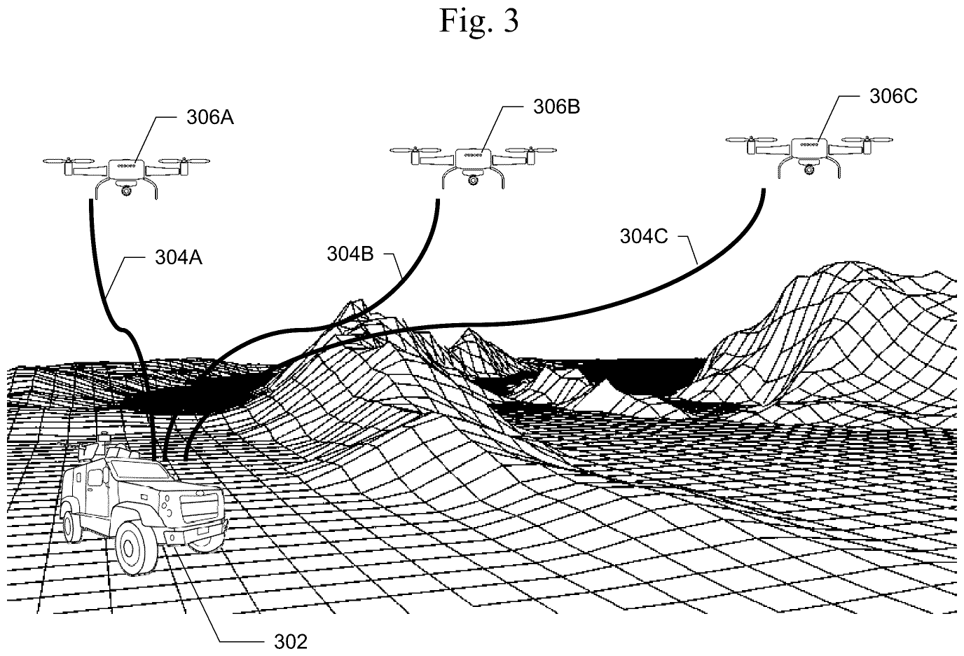

An example of operation of embodiments of the present systems and methods is shown in FIG. 3. In this example, self-aware mobile system 302 may be in communication 304A-C with autonomous sensor platforms 306A-C. Autonomous sensor platforms 306A-C may provide the capability to sense conditions surrounding self-aware mobile system 302, including in the immediate vicinity of self-aware mobile system 302, as well as more distant conditions. Such conditions may include, for example, the presence and location of terrain, structures, vehicles, vessels, aircraft, persons, etc. More distant conditions may include, for example, conditions obscured by obstacles, such as other vehicles, structures, terrain, etc., as well as conditions too remote to ordinarily be sensed from self-aware mobile system 302, such as over terrain, over-the-horizon, etc.

Although embodiments have been described in terms of self-aware mobile systems and drone autonomous sensor platforms, the present techniques are equally applicable to other embodiments as well. For example, the focal point may be a self-aware mobile system 302, other vehicles, water-going vessels, aircraft, or fixed installations, such as buildings. Autonomous sensor platforms may include drones, whether long, medium, or short endurance, as well as sensors mounted on other vehicles, vessels, aircraft, satellites, etc., as long as data from the sensor platforms is communicated to the focal point, such as self-aware mobile system 302. Autonomous sensor platforms may include sensor such as cameras, LIDAR, RADAR, radiation detectors, chemical detectors, etc., an any other type of condition sensor that may be available.

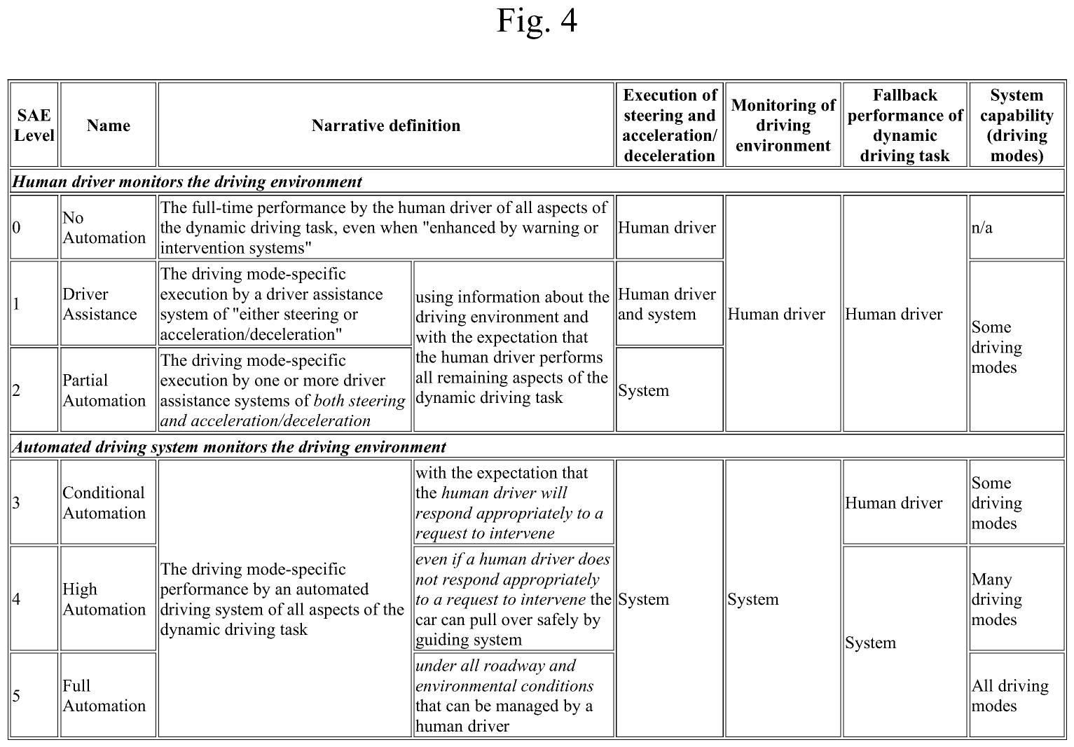

An exemplary diagram of the SAE standard levels of automation for vehicles is shown in FIG. 4. Even though this example shows levels of automation for vehicles being driven, the automation levels themselves are applicable to operation of any type of vehicle, vessel, aircraft, etc. In embodiments, the present techniques may provide level 4 and level 5 automation for vehicles, vessels, aircraft, etc. using HIM processing, described below.

Hierarchical Intelligence Model (HIM) processing. Autonomous systems (AS) used to be perceived as an Internet protocol in industry. Machine learning and control theories focus on human-system interactions in AS' where humans are in-the-loop cooperating with the machine. NATO refers AS to a system that “exhibits goal-oriented and potentially unpredictable and non-fully deterministic behaviors.

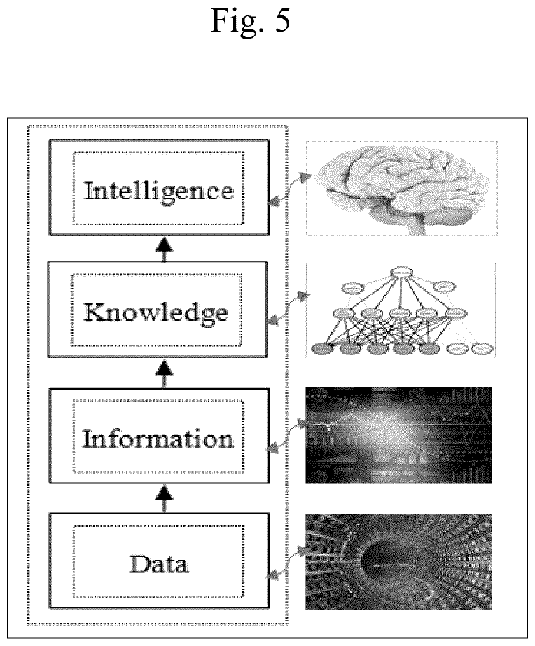

The natural and machine intelligence underpinning autonomous systems may be inductively generated through data, information, and knowledge as illustrated in FIG. 5 from the bottom up. FIG. 5 indicates that intelligence may not be directly aggregated from data as some neural network technologies inferred, because there are multiple inductive layers from data to intelligence. Therefore, a matured AS would be expected to be able to independently discover a law in sciences (inductive intelligence) or autonomously comprehend the semantics of a joke in natural languages (inference intelligence). None of them is trivial in order to extend the AS' intelligence power beyond data aggregation abilities.

Intelligence is the paramount cognitive ability of humans that may be mimicked by computational intelligence and cognitive systems. Intelligence science studies the general form of intelligence, formal principles and properties, as well as engineering applications. This section explores the cognitive and intelligent foundations of AS underpinned by intelligence science.

The intension and extension of the concept of intelligence, C₁ (intelligence), may be formally described by a set of attributes (A₁) and of objects (O₁) according to concept algebra:

$$( 1 )$$

$${C}_{1} ( intelligence : {A}_{1} , {O}_{1} , {R}_{1}^{c} , {R}_{1}^{i} , {R}_{1}^{o} ) = \{ \begin{matrix}\begin{matrix}\begin{matrix}\begin{matrix}{A}_{1} = \begin{matrix}\begin{matrix}\begin{matrix}\{ {cognitive\_object}^{*} , mental\_power , aware\_to \_be , \\ able\_to \_do , process , execution ,\end{matrix} \\ transfer\_information \_to \_knowledge ,\end{matrix} \\ transfer\_information \_to \_behavior \}\end{matrix} \\ {O}_{1} = \begin{matrix}\{ brain , robots , {natural}_{i} , AI , {animal}_{i} , {reflexive}_{i} , {imperative}_{i} , \\ {adaptive}_{i} , {autonomous}_{i} , {cognitive}_{i} \}\end{matrix}\end{matrix} \\ {R}_{1}^{c} = {O}_{1} \times {A}_{1}\end{matrix} \\ {R}_{1}^{i} ⊆ \times {C}_{1}\end{matrix} \\ {R}_{1}^{o} ⊆ {C}_{1} \times \end{matrix}$$

where R₁^{c}, R₁ⁱ, and R₁^{o} represent the sets of internal and input/output relations of C₁ among the objects and attributes or from/to existing knowledge [symbol] as the external context.

Definition 1. Intelligence [symbol] is a human, animal, or system ability that autonomously transfers a piece of information I into a behavior B or an item of knowledge K, particularly the former, i.e.:

[symbol]

=ƒ_{to-do}:I→B|ƒ_{to-be}:I→K (2)

Intelligence science is a contemporary discipline that studies the mechanisms and properties of intelligence, and the theories of intelligence across the neural, cognitive, functional, and mathematical levels from the bottom up.

A classification of intelligent systems may be derived based on the forms of inputs and outputs dealt with by the system as shown in Table 1. The reflexive and imperative systems may be implemented by deterministic algorithms or processes. The adaptive systems can be realized by deterministic behaviors constrained by the predefined context. However, AS is characterized as having both varied inputs and outputs where its inputs must be adaptive, and its outputs have to be rationally fine-tuned to problem-specific or goal-oriented behaviors.

TABLE 1
Classification of autonomous and nonautonomous systems

Behavior (O)

| | | Constant | Varied |
|---|---|---|---|
| Stimulus (I) | Constant | Reflexive | Adaptive |
| | Varied | Imperative | Autonomous |

According to Definition 1 and Table 1, AS is a highly intelligent system for dealing with variable events by flexible and fine-tuned behaviors without the intervention of humans.

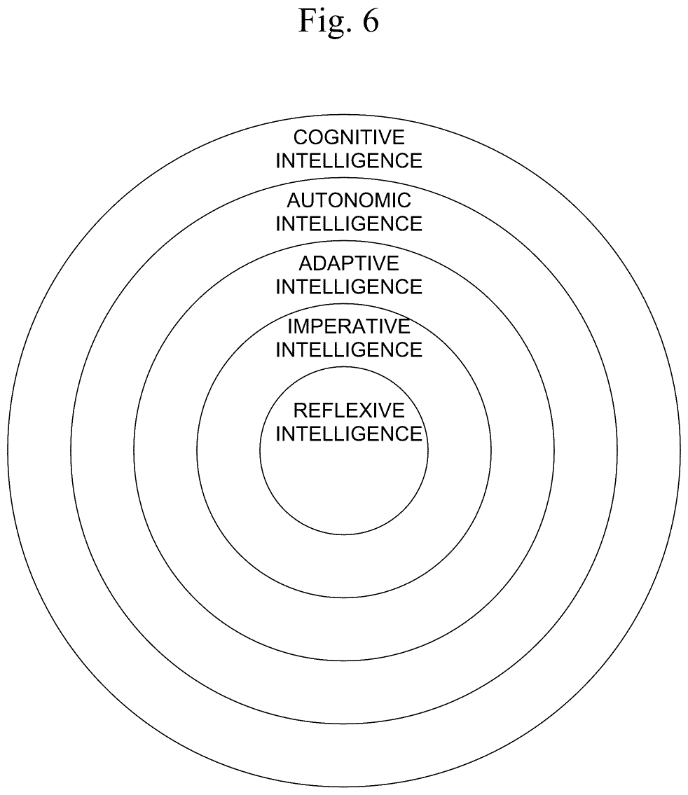

The Hierarchical Model of Intelligence. A hierarchical intelligence model (HIM) is created for identifying the levels of intelligence and their difficulty for implementation in computational intelligence as shown in FIG. 6 based on the abstract intelligence (αI) theory. In HIM, the levels of intelligence are aggregated from reflexive, imperative, adaptive, autonomous, and cognitive intelligence with 16 categories of intelligent behaviors. Types of system intelligence across the HIM layers are formally described in the following subsections using the stimulus/event-driven formula as defined in Eq. 2.

Reflexive Intelligence. Reflexive intelligence [symbol] _{ref} is the bottom-layer intelligence coupled by a stimulus and a reaction. [symbol] _{ref} is shared among humans, animals, and machines, which forms the foundation of higher layer intelligence.

Definition 2. The reflexive intelligence [symbol] _{ref} is a set of wired behaviors B ref directly driven by specifically coupled external stimuli or trigger events @eᵢ|REF, i.e.:

$${ref}_{} {{R}_{i = 1}}^{{n}_{ref}} @ {e}_{i} \vert REF {B}_{ref} ( i ) \vert PM \qquad ( 3 )$$

where the big-R notation is a mathematical calculus that denotes a sequence of iterative behaviors or a set of recurring structures, [symbol] is a dispatching operator between an event and a specified function, @ the event prefix of systems, |REF the string suffix of a reflexive event, and |PM the process model suffix.

Imperative Intelligence Imperative intelligence [symbol] ᵢₘₚ is a form of instructive and reflective behaviors dispatched by a system based on the layer of reflexive intelligence. [symbol] ᵢₘₚ encompasses event-driven behaviors (Bᵢₘₚ^{e}), time-driven behaviors(Bᵢₘₚ^{t}), and interruptdriven behaviors (Bᵢₘₚ^{int}).

Definition 3. The event-driven intelligence [symbol] ᵢₘₚ^{e} is a predefined imperative behavior Bᵢₘₚ^{e} driven by an event @ eᵢ|E, such as:

$${imp}_{e}^{} {{R}_{i = 1}}^{{n}_{e}} @ {e}_{i} \vert E {B}_{imp}^{e} ( i ) \vert PM \qquad ( 4 )$$

Definition 4. The time-driven intelligence [symbol] ᵢₘₚ^{t}, is a predefined imperative behavior Bᵢₘₚ^{t} driven by a point of time @eᵢ|TM, such as:

$${imp}_{t}^{} {{R}_{i = 1}}^{{n}_{t}} @ {e}_{i} \vert TM {B}_{imp}^{t} ( i ) \vert PM \qquad ( 5 )$$

where @ eᵢ|TM may be a system or external timing event.

Definition 5. The interrupt-driven intelligence z″ᵢₘₚ^{int} is a predefined imperative behavior Bᵢₘₚ^{int} driven by a system triggered interrupt event @eᵢ| [symbol] , such as:

$${imp}_{int}^{} {{R}_{i = 1}}^{{n}_{int}} @ {e}_{i} \vert {B}_{imp}^{int} ( i ) \vert PM \qquad ( 6 )$$

where the interrupt, @intᵢ [symbol] , triggers an embedded process, B₁|PM [symbol] B₂|PM=B₁|PM∥(eᵢₙₜⁱ|⊙ [symbol] B₂|PM [symbol] ⊙), where the current process B₁ is temporarily held by a higher priority process B₂ requested by the interrupt event at the interrupt point [symbol] . The interrupted process will be resumed when the high priority process has been completed. The imperative system powered by [symbol] ᵢₘₚ is not adaptive, and may merely implement deterministic, context-free, and stored program controlled behaviors.

Adaptive Intelligence. Adaptive intelligence [symbol] _{αdp} is a form of run-time determined behaviors where a set of predictable scenarios is determined for processing variable problems. [symbol] _{αdp} encompasses analogy-based behaviors (B_{αdp}^{ab}), feedback-modulated behaviors (B_{αdp}^{fm}), and environment-awareness behaviors (B_{αdp}^{ea}).

Definition 6. The analogy-based intelligence [symbol] _{αdp}^{ab} is a set of adaptive behavior B_{αdp}^{ab} that operate by seeking an equivalent solution for a given request @eᵢ|RQ, such as:

$${adp}_{ab}^{} {{R}_{i = 1}}^{{n}_{ab}} @ {e}_{i} \vert RQ {B}_{adp}^{ab} ( i ) \vert PM \qquad ( 7 )$$

Definition 7. The feedback-modulated intelligence [symbol] _{αdp}^{fm} is a set of adaptive behaviors B_{αdp}^{fm} rectified by the feedback of temporal system output @eᵢ|FM, such as:

$${adp}_{fm}^{} {{R}_{i = 1}}^{{m}_{fm}} @ {e}_{i} \vert F M {B}_{adp}^{fm} ( i ) \vert P M \qquad ( 8 )$$

Definition 8. The environment-awareness intelligence [symbol] _{αdp}^{ea} is a set of adaptive behavior B_{αdp}^{ea} where multiple prototype behaviors are modulated by the change of external environment @eᵢ|EA, such as:

$${adp}_{ep}^{} {{R}_{i = 1}}^{{m}_{fm}} @ {e}_{i} \vert E A {B}_{adp}^{ea} ( i ) \vert P M \qquad ( 9 )$$

[symbol] _{αda} is constrained by deterministic rules where the scenarios are prespecified. If a request is out of the defined domain of an adaptive system, its behaviors will no longer be adaptive or predictable.

Autonomous Intelligence. Autonomous intelligence [symbol] _{αut} is the fourth-layer intelligence powered by internally motivated and self-generated behaviors underpinned by senses of system consciousness and environment awareness. [symbol] _{αut} encompasses the perceptive behaviors (B_{αut}^{pe}), problem-driven behaviors (B_{αut}^{pd}), goal oriented behaviors (B_{αut}^{go}), decision-driven behaviors (B_{αut}^{dd}), and deductive behaviors (B_{αut}^{de}) built on the Layers 1 through 3 intelligent behaviors.

Definition 9. The perceptive intelligence [symbol] _{αut}^{pe} is a set of autonomous behaviors B_{αut}^{pe} based on the selection of a perceptive inference @eᵢ|PE, such as:

$${aut}_{pe}^{} {{R}_{i = 1}}^{{n}_{pe}} @ {e}_{i} \vert P E {B}_{aut}^{pe} ( i ) \vert P M \qquad ( 10 )$$

Definition 10. The problem-driven intelligence [symbol] _{αut}^{pd} is a set of autonomous behaviors B_{αut}^{pd} that seeks a rational solution for the given problem @eᵢ|PD, such as:

$${aut}_{pd}^{} {{R}_{i = 1}}^{{n}_{pd}} @ {e}_{i} \vert P D {B}_{aut}^{pd} ( i ) \vert P M \qquad ( 11 )$$

Definition 11. The goal-oriented intelligence [symbol] _{αut}^{go} is a set of autonomous behaviors B_{αut}^{go} seeking an optimal path towards the given goal @eᵢ|GO, such as:

$${aut}_{go}^{} {{R}_{i = 1}}^{{n}_{go}} @ {e}_{i} \vert G O {B}_{aut}^{go} ( i ) \vert P M \qquad ( 12 )$$

where the goal, g|SM=(P, Ω, Θ), is a structure model (SM) in which P is a finite nonempty set of purposes or motivations, Ω a finite set of constraints to the goal, and Θ the environment of the goal.

Definition 12. A decision-driven intelligence [symbol] _{αut}^{dd}, is a set of autonomous behaviors B_{αut}^{dd} driven by the outcome of a decision process @eᵢ|DD, such as:

$${aut}_{dd}^{} {{R}_{i = 1}}^{{n}_{dd}} @ {e}_{i} \vert D D {B}_{aut}^{dd} ( i ) \vert P M \qquad ( 13 )$$

where the decision, d|SM=(A, C), is a structure model in which A is a finite nonempty set of alternatives, and C a finite set of criteria.

Definition 13. The deductive intelligence [symbol] _{αut}^{de} is a set of autonomous behaviors B_{αut}^{de} driven by a deductive process @eᵢ|DE based on known principles, such as:

$${aut}_{de}^{} {{R}_{i = 1}}^{{n}_{de}} @ {e}_{i} \vert D E {B}_{aut}^{de} ( i ) \vert P M \qquad ( 14 )$$

[symbol]

_{αut} is self-driven by the system based on internal consciousness and environmental awareness beyond the deterministic behaviors of adaptive intelligence. [symbol] _{αut} represents nondeterministic, context-dependent, run-time autonomic, and self-adaptive behaviors.

Cognitive Intelligence. Cognitive intelligence [symbol] _{cog} is the fifth-layer of intelligence that generates inductive- and inference-based behaviors powered by autonomous reasoning. [symbol] _{cog} encompasses the knowledge-based behaviors (B_{cog}^{kb}), learning-driven behaviors (B_{cog}^{ld}), inference-driven behaviors (B_{cog}^{kb}), and inductive behaviors (B_{cog}^{id}) built on the intelligence powers of Layers 1 through 4.

Definition 14. The knowledge-based intelligence [symbol] _{cog}^{kb}, is a set of cognitive behaviors B_{cog}^{kb} generated by introspection of acquired knowledge @eᵢ|KB

$${cog}_{kb}^{} {{R}_{i = 1}}^{{n}_{kb}} @ {e}_{i} \vert K B {B}_{cog}^{kb} ( i ) \vert P M \qquad ( 15 )$$

Definition 15. The learning-driven intelligence [symbol] _{cog}^{ld}, is a set of cognitive behaviors B_{cog}^{ld} generated by both internal introspection and external searching @eᵢ|LD, such as:

$${cog}_{ld}^{} {{R}_{i = 1}}^{{n}_{ld}} @ {e}_{i} \vert L D {B}_{cog}^{ld} ( i ) \vert P M \qquad ( 16 )$$

Definition 16. The inference-driven intelligence [symbol] _{cog}^{if} is a set of cognitive behaviors B_{cog}^{if} that creates a causal chain from a problem to a rational solution driven by @eᵢ|IF, such as:

$${cog}_{if}^{} {{R}_{i = 1}}^{{n}_{if}} @ {e}_{i} \vert I F {B}_{cog}^{if} ( i ) \vert P M \qquad ( 17 )$$

Definition 17. The inductive intelligence [symbol] _{cog}^{id} is a set of cognitive behaviors B_{cog}^{id}, that draws a general rule based on multiple observations or common properties @eᵢ|ID, such as:

$${cog}_{id}^{} {{R}_{i = 1}}^{{n}_{ld}} @ {e}_{i} \vert I D {B}_{cog}^{id} ( i ) \vert P M \qquad ( 18 )$$

[symbol] _{cog} is nonlinear, nondeterministic, context-dependent, knowledge-dependent, and self-constitute, which represents the highest level of system intelligence mimicking the brain. [symbol] _{cog} indicates the ultimate goal of AI and machine intelligence. The mathematical models of HIM indicate that the current level of machine intelligence has been stuck at the level of [symbol] _{αdp} for the past 60 years. One would rarely find any current AI system that is fully autonomous comparable to the level of human natural intelligence.

THE THEORY OF AUTONOMOUS SYSTEMS. On the basis of the HIM models of intelligence science as elaborated in the preceding section, autonomous systems will be derived as a computational implementation of autonomous intelligence aggregated from the lower layers.

Properties of System Autonomy and Autonomous Systems. According to the HIM model, autonomy is a property of intelligent systems that “can change their behavior in response to unanticipated events during operation” “without human intervention.”

Definition 18. The mathematical model of an AS is a high-level intelligent system for implementing advanced and complex intelligent abilities compatible to human intelligence in systems, such as:

$$A S {{R}_{i = 1}}^{{n}_{AS}} @ {e}_{AS}^{i} \vert S [ {B}_{AS} ( i ) \vert P M \vert {B}_{AS} ( i ) \vert P M \geq 4 ] \qquad ( 19 )$$

which extends system intelligent power from reflexive, imperative, and adaptive to autonomous and cognitive intelligence.

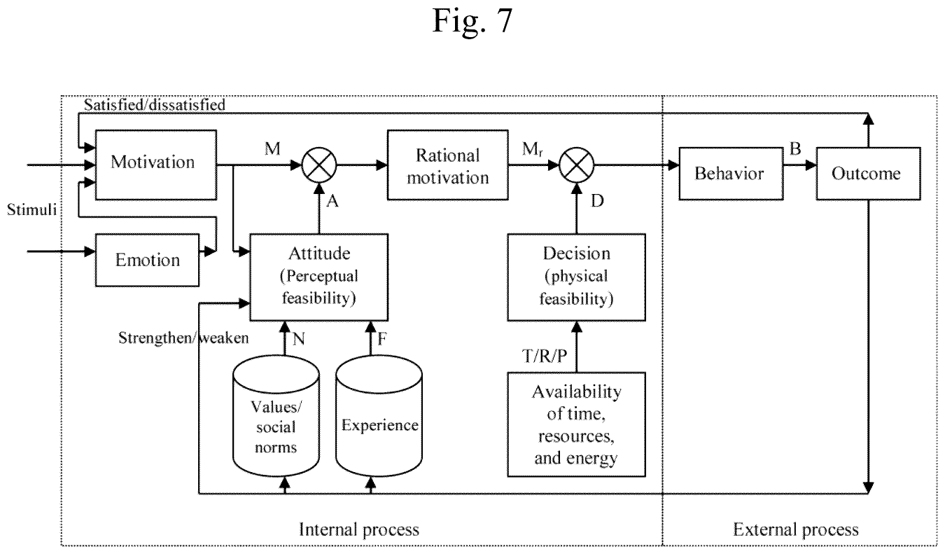

AS implements nondeterministic, context-dependent, and adaptive behaviors. AS is a nonlinear system that depends not only on current stimuli or demands, but also on internal status and willingness formed by long-term historical events and current rational or emotional goals (see FIG. 7). The major capabilities of AS will need to be extended to the cognitive intelligence level towards highly intelligent systems beyond classic adaptive and imperative systems.

Lemma 1. The behavioral model of AS, AS|§, is inclusively aggregated from the bottom up, such as:

$$\begin{matrix} \\ A S \vert \begin{matrix}S \\ S\end{matrix} ( {B}_{Ref} , {B}_{Imp} , {B}_{Adp} , {B}_{Aut} , {B}_{Cog} ) \\ = \{ ( {B}_{rf} ) // {B}_{Ref} \\ \vert \vert ( {B}_{e} , {B}_{t} , {B}_{int} ) ⋃ {B}_{Ref} // {B}_{Imp} \\ \vert \vert ( {B}_{ab} , {B}_{fm} , {B}_{ea} ) ⋃ {B}_{Imp} ⋃ {B}_{Ref} // {B}_{Ada} \\ \vert \vert ( {B}_{pe} , {B}_{pd} , {B}_{go} , {B}_{dd} , {B}_{de} ) ⋃ {B}_{Adp} ⋃ {B}_{Imp} ⋃ {B}_{Ref} // {B}_{Aut} \\ \vert \vert ( {B}_{kb} , {B}_{id} , {B}_{if} , {B}_{id} ) ⋃ {B}_{Aut} ⋃ {B}_{Adp} ⋃ {B}_{Imp} ⋃ {B}_{Ref} // {B}_{Cog} \\ \} \end{matrix} \qquad ( 20 )$$

where ∥ denotes a parallel relation, |§ the system suffix, and each intelligent behavior has been formally defined above.

Proof. Lemma 1 can be directly proven based on the definitions in the HIM model.

Theorem 1. The relationships among all levels of intelligent behaviors as formally modeled in HIM are hierarchical (a) and inclusive (b), i.e.:

$$H I M \vert \begin{matrix}S \\ S\end{matrix} \{ \begin{matrix}a ) {{R}_{k = 1}}^{4} {B}^{k} ( {B}^{k - 1} ) , {B}^{0} = {{R}_{i = 1}}^{{n}_{ref}} @ {e}_{i} \vert R E F {B}_{ref} ( i ) \vert P M \\ b ) {B}_{Cop} ⊇ {B}_{Aut} ⊇ {B}_{Ada} ⊇ {B}_{Imp} ⊇ {B}_{Ref}\end{matrix} \qquad ( 21 )$$

Proof. According to Lemma 1, a) Since

$${{R}_{k = 1}}^{4} {B}^{k} ( {B}^{k - 1} )$$

in Eq.21(a) aggregates B⁰ through B⁴ hierarchically, the AS can be deductively reduced from the top down as well as inductively composed from the bottom up when B⁰ is deterministic; b) Since Eq. 21(b) is a partial order, it is inclusive between adjacent layers of system intelligence from the bottom up.

Theorem 1 indicates that any lower layer behavior of an AS is a subset of those of a higher layer. In other words, any higher layer behavior of AS is a natural aggregation of those of lower layers as shown in FIG. 6 and Eqs. 20/21. Therefore, Theorem 1 and Lemma 1 reveals the necessary and sufficient condition of AS.

The Effect of Human in Hybrid Autonomous Systems Because the only matured paradigm of AS is the brain, advanced AS is naturally open to incorporate human intelligence as indicated by the HIM model. This notion leads to a broad form of hybrid AS with coherent human-system interactions. Therefore, human factors play an irreplaceable role in hybrid AS in intelligence and system theories.

Definition 19. Human factors are the roles and effects of humans in a hybrid AS that introduces special strengths, weaknesses, and/or uncertainty.

The properties of human strengths in AS are recognized such as highly matured autonomous behaviors, complex decision-making, skilled operations, comprehensive senses, flexible adaptivity, perceptive power, and complicated system cooperation. However, the properties of human weaknesses in AS are identified such as low efficiency, tiredness, slow reactions, error-proneness, and distraction. In addition, a set of human uncertainty in AS is revealed such as productivity, performance, accuracy, reaction time, persistency, reliability, attitude, motivation, and the tendency to try unknown things even if they are prohibited.

We found that human motivation, attitude, and social norms (rules) may affect human perceptive and decision making behaviors as well as their trustworthiness as shown in FIG. 7 by the Autonomous Human Behavior Model (AHBM). AHBM illustrates the interactions of human perceptive behaviors involving emotions, motivations, attitudes, and decisions. In the AHBM model, a rational motivation, decision and behavior can be quantitatively derived before an observable action is executed. The AHBM model of humans in AS may be applied as a reference model for trustworthy decision-making by machines and cognitive systems.

According to Theorem 1 and Lemma 1, a hybrid AS with humans in the loop will gain strengths towards the implementation of cognitive intelligent systems. The cognitive AS will sufficiently enable a powerful intelligent system by the strengths of both human and machine intelligence. This is what intelligence and system sciences may inspire towards the development of fully autonomous systems in highly demanded engineering applications.

CONCLUSION It has been recognized that autonomous systems are characterized by the power of perceptive, problem-driven, goal-driven, decision-driven, and deductive intelligence, which are able to deal with unanticipated and indeterministic events in real-time. This work has explored the intelligence and system science foundations of autonomous systems. A Hierarchical Intelligence Model (HIM) has been developed for elaborating the properties of autonomous systems built upon reflexive, imperative, and adaptive systems. The nature of system autonomy and human factors in autonomous systems has been formally analyzed. This work has provided a theoretical framework for developing cognitive autonomous systems towards highly demanded engineering applications including brain-inspired cognitive systems, unmanned systems, self-driving vehicles, cognitive robots, and intelligent IoTs.

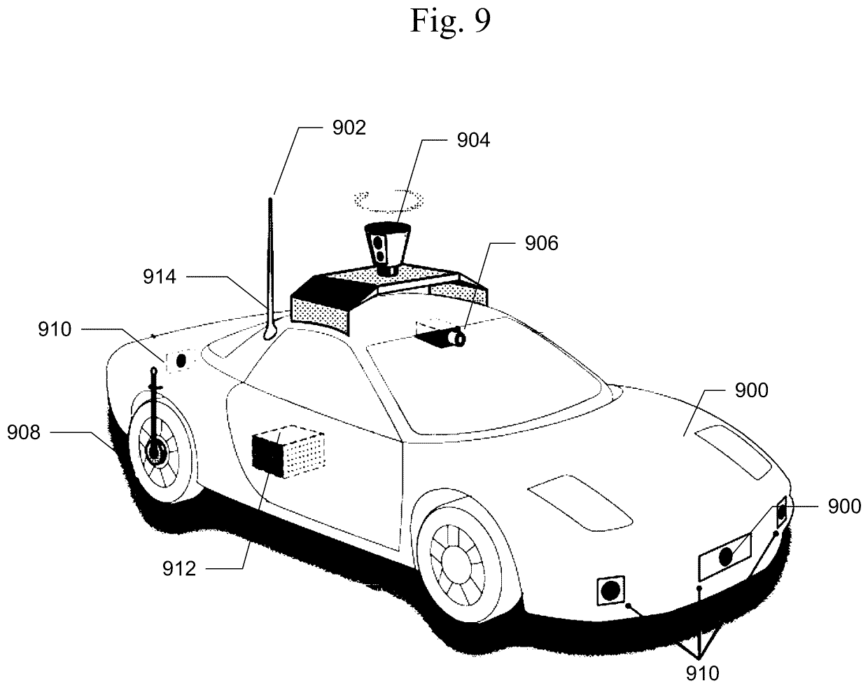

Turning now to FIG. 9, an exemplary embodiment of a self-driving vehicle 900, such as a car, which may be partially or completely autonomous, is shown. Vehicle 900 may include GPS receiver 902, LIDAR 904, one or more video cameras 906, ultrasonic sensors 908, RADAR sensors 910, computer system 912, and a communications transceiver 914. GPS receiver 902 may receive signals from GPS (Global Positioning System) satellites to determine a position of vehicle 900. The received signals may be combined with readings from tachometers. altimeters, gyroscopes, etc., to provide more accurate positioning than is possible with GPS alone. LIDAR (Light Detection and Ranging) sensors may bounce pulses of light off the surroundings. These may be analyzed to identify lane markings, the edges of roads, buildings, other vehicles, and other features in the vicinity of vehicle 900. Video cameras 906 may detect traffic lights, read road signs, keep track of the positions of other vehicles and look out for pedestrians and obstacles on the road, as well as other features in the vicinity of vehicle 900. Ultrasonic sensors 908 may be used to measure the position of objects very close to the vehicle, such as curbs and other vehicles when parking. Radar sensors 910 may monitor the position of other vehicles nearby. Such sensors are already used, for example, in adaptive cruise-control systems. The information from all of the sensors may be analyzed by a central computer 912 that manipulates the steering, accelerator, and brakes. The software must understand the rules of the road or the mission, both formal and informal. Communications transceiver 914 may provide communicative connectivity with other vehicles, autonomous sensor platforms, and a monitoring or command station, and may provide communications of commands, status data, telemetry data, and sensor data with the other vehicles, autonomous sensor platforms, and the monitoring or command station.

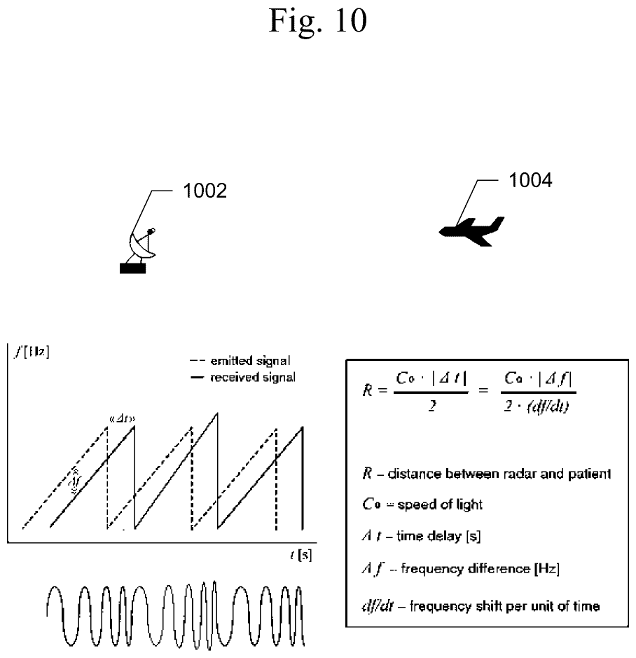

An exemplary diagram of the operation of a RADAR system is shown in FIG. 10. In this example, a RADAR transceiver 1002 and a target 1004 are shown. Radar transceiver 1002 emits a signal, which is reflected from target 1004, and the reflected signal is received by RADAR transceiver 1002. The distance between RADAR transceiver 1002 and target 1004 may be computed as a function of the time delay between transmission of the emitted signal and the reception of the reflected signal. The difference in velocity between RADAR transceiver 1002 target 1004 may be computed as a function of the frequency difference between the emitted signal and the received signal and frequency shift per unit time of the received signal. RADAR relies on radio waves. With typical current technology development, objects may be detected at ranges of, for example, 1 km. Advantages of RADAR systems may include insensitivity to weather conditions due to its penetration abilities, very accurate estimation of velocity and distance, wide operation range (1 km), and lower cost compared to other high-level systems.

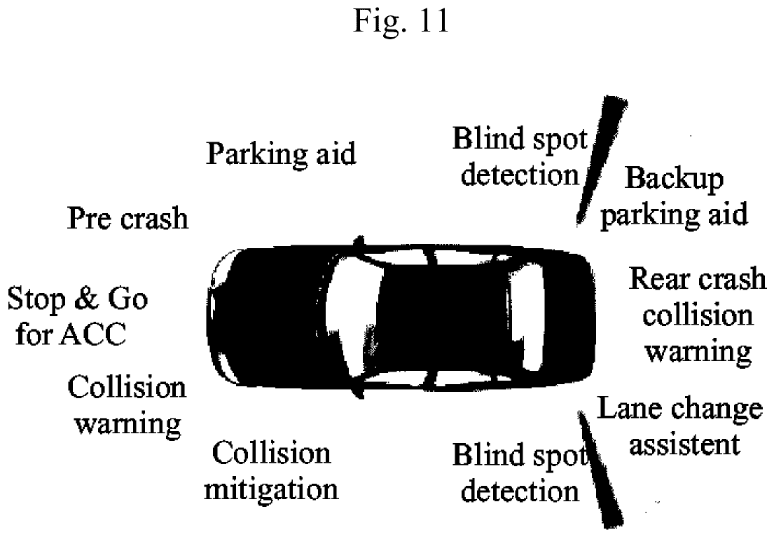

Examples of applications of RADAR to autonomous vehicles are shown in FIG. 11. Such applications may include stop and go for adaptive cruise control, pre-crash warning or avoidance, parking aid, blind spot detection, backup parking aid, rear crash collision warning, lane change assistance, collision mitigation, and collision warning.

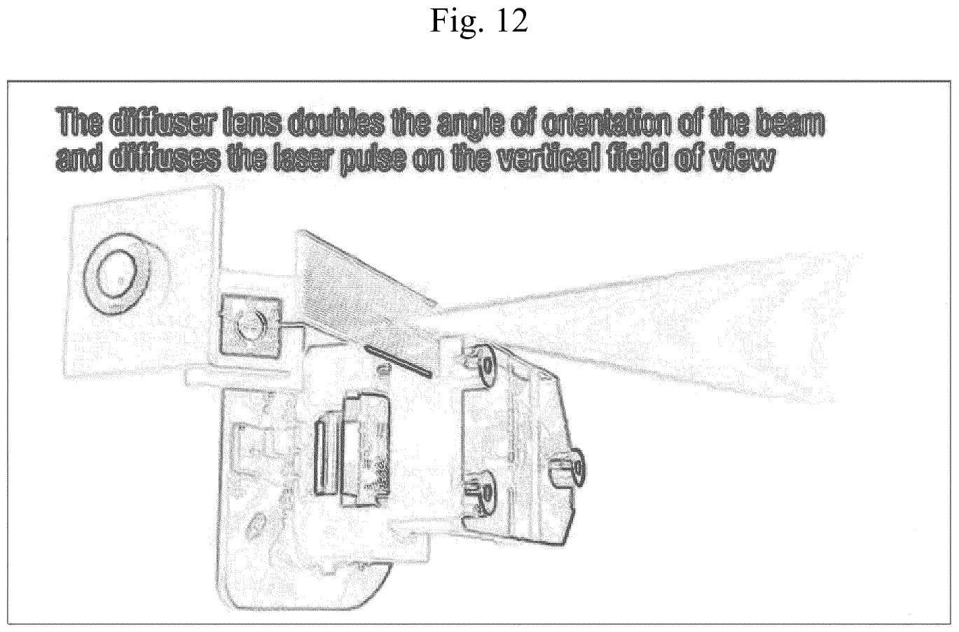

An exemplary LIDAR system is shown in FIG. 12. LIDAR uses laser beams (light waves) to determine the distance between two objects. LIDAR may be mounted on top of vehicles and is rotated at high speed while emitting laser beams. The laser beams reflect from the obstacles and travel back to the device. A diffuser lens may be used to double the angle of orientation of the beam and may diffuse the laser pulse on the vertical field of view. Advantages of LIDAR may include that it works both day and night, provides extremely precise and accurate data, provides a 3-D representation of surroundings, provides object classification, and creates maps of surroundings with high resolution.

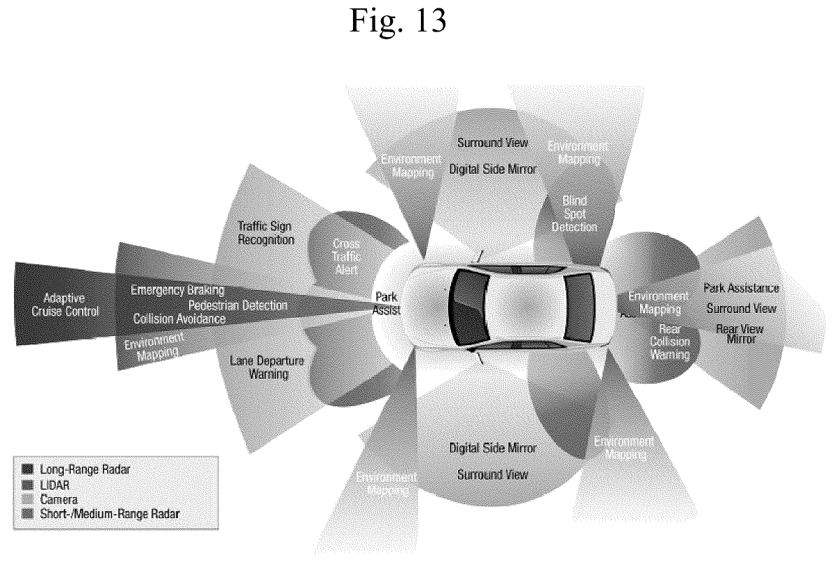

Examples of applications of RADAR, cameras, and LIDAR to autonomous vehicles are shown in FIG. 13. Such applications may include adaptive cruise control, emergency braking, pedestrian detection, collision avoidance, environmental mapping, traffic sign recognition, lane departure warning, cross traffic alerts, surround view, digital side mirror, blind spot detection, rear collision warning, parking assistance, and rear view mirror.

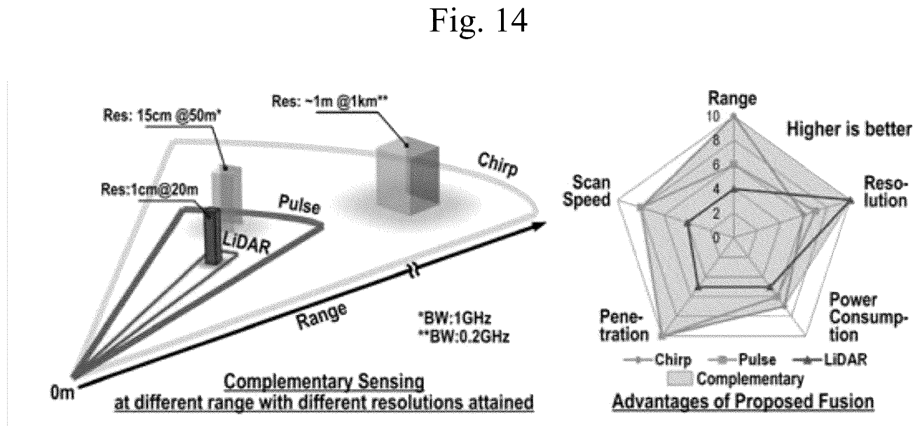

An example of RADAR/LIDAR fusion is shown in FIG. 14. LIDAR alone may lack reliability: it depends on the weather conditions, can self-deceive itself with echoes, and is not a long-distance function. RADAR alone may lack resolution, some small objects may not be detected. RADAR/LIDAR fusion technology is weather-proof, high-range and high resolution technology. Weaknesses of separate technologies may be nullified. RADAR/LIDAR fusion may provide complementary sensing at different ranges with different resolutions attained.

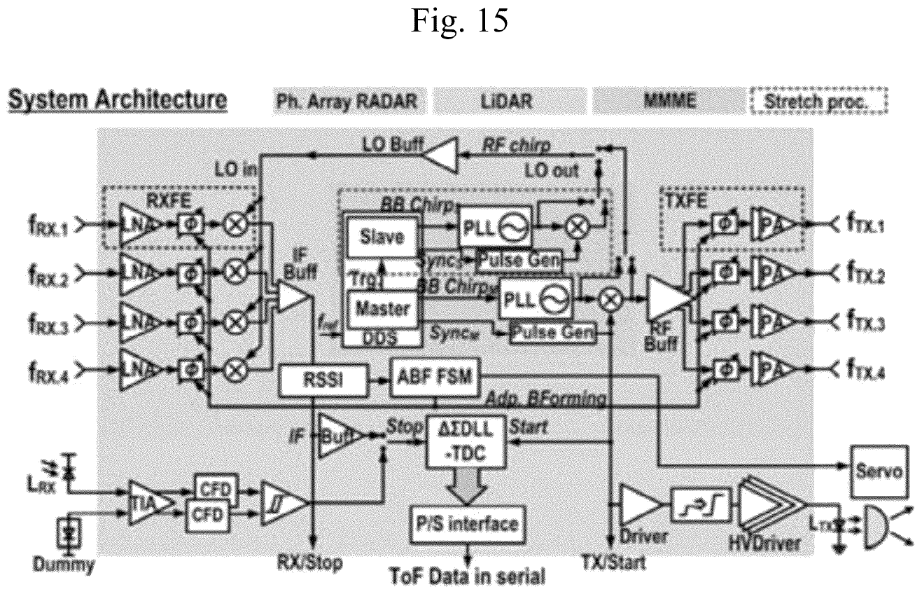

An example of a system providing RADAR/LIDAR fusion is shown in FIG. 15. The exemplary system architecture may include RADAR, LIDAR, and multimodal modulation engine (MMME) technology. Smart sensing may provide comprehensive and effective environment information through complementary signals in data acquisition.

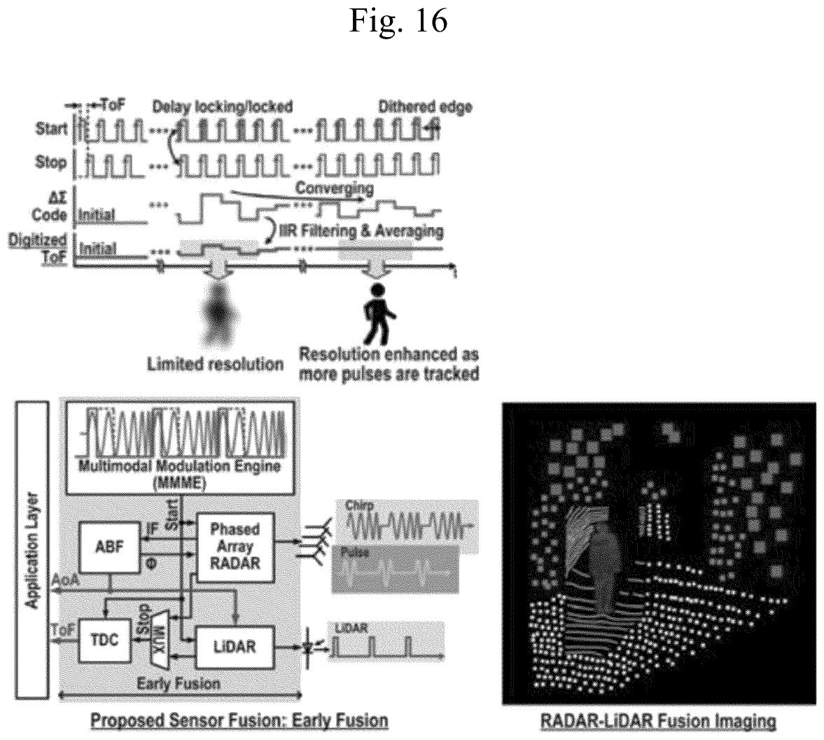

An example of a system providing RADAR/LIDAR fusion is shown in FIG. 16. Advantages may include 100-500 meters range, object classification, night vision, object penetration, self-adjustable focus due to automatic enhancement of resolution, etc.

True Vision Autonomous (TVA) may provide artificial vision based multisensory integration or multimodal integration of some or all sensor technologies, including at least RADAR/LIDAR fusion, but also may include video, ultrasonic, GPS, etc. technologies, all fused to provide data in a common and compatible way. TVA may provide advantages such as short-long distance detection (up to 1 kilometer range), detection of small objects, high resolution, ability to see through objects, independence from weather conditions, defense against malfunctions created by echoes, etc. In embodiments, TVA data may be used to provide autonomous functioning of a vehicle, vessel, or aircraft at any level of automation, such as the SAE automation levels shown in FIG. 4. In embodiments, TVA data may be displayed to a human operator of the vehicle, vessel, or aircraft, whether the human operation is located in the vehicle, vessel, or aircraft or is located remotely from vehicle, vessel, or aircraft, so as to provide automation assistance. In embodiments, TVA data may be used to provide up to full automation of the vehicle, vessel, or aircraft.

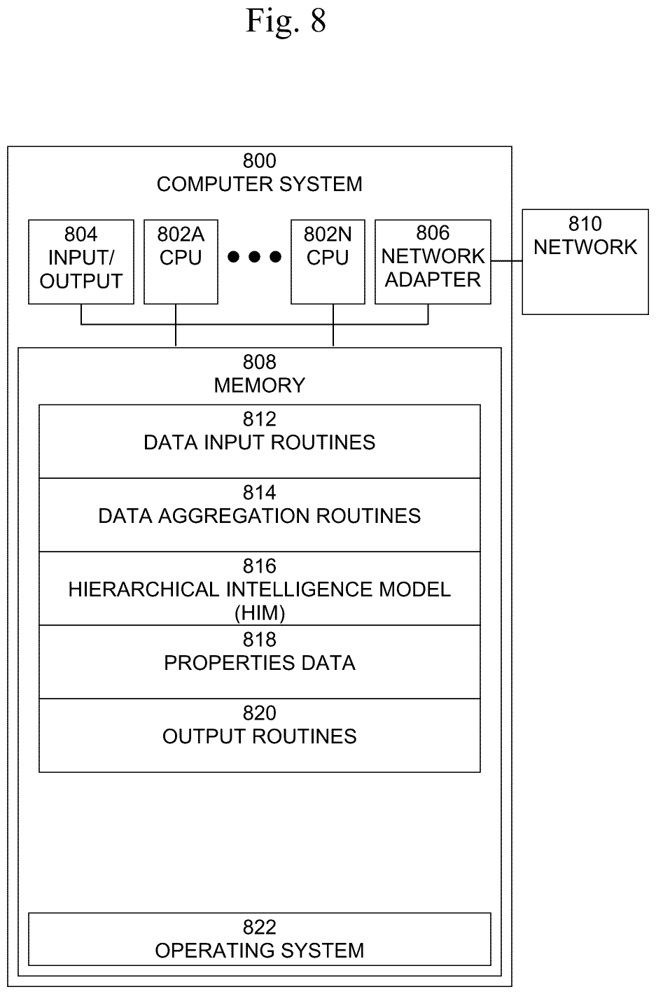

An exemplary block diagram of a computer system 800, in which processes involved in the embodiments described herein may be implemented, is shown in FIG. 8. Computer system 802 may be implemented using one or more programmed general-purpose computer systems, such as embedded processors, systems on a chip, personal computers, workstations, server systems, and minicomputers or mainframe computers, or in distributed, networked computing environments. Computer system 802 may include one or more processors (CPUs) 802A-802N, input/output circuitry 804, network adapter 806, and memory 808. CPUs 802A-802N execute program instructions in order to carry out the functions of the present communications systems and methods. Typically, CPUs 802A-802N are one or more microprocessors, such as an INTEL CORE® processor. FIG. 8 illustrates an embodiment in which computer system 802 is implemented as a single multi-processor computer system, in which multiple processors 802A-802N share system resources, such as memory 808, input/output circuitry 804, and network adapter 806. However, the present communications systems and methods also include embodiments in which computer system 802 is implemented as a plurality of networked computer systems, which may be single-processor computer systems, multi-processor computer systems, or a mix thereof.

Input/output circuitry 804 provides the capability to input data to, or output data from, computer system 802. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 806 interfaces device 800 with a network 810. Network 810 may be any public or proprietary LAN or WAN, including, but not limited to the Internet.

Memory 808 stores program instructions that are executed by, and data that are used and processed by, CPU 802 to perform the functions of computer system 802. Memory 808 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 808 may vary depending upon the function that computer system 802 is programmed to perform. In the example shown in FIG. 8, exemplary memory contents are shown representing routines and data for embodiments of the processes described above. For example, FIG. 8 includes memory contents for both a client 812 and a server 814. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 8, memory 808 may include memory contents for self-aware mobile systems and autonomous sensor platforms. Memory contents may include data input routines 812, data aggregation routines 814, Hierarchical Intelligence Model (HIM) routines 816, properties data 818, output routines 820, and operating system 822. Data input routines 812 may include software to accept input data from sensors attached to autonomous sensor platforms or received from autonomous sensor platforms. Data aggregation routines 814 may include software to accept input data and process and aggregate such data for use by self-aware mobile systems and autonomous sensor platforms. Hierarchical Intelligence Model (HIM) routines 816 may include software to process data, generate commands to autonomous sensor platforms, and generate intelligent behaviors for one or more self-aware mobile systems and/or autonomous sensor platforms so as to elaborate the evolution of human and system intelligence as an inductive process. Properties data 818 may include a set of properties used for system autonomy that may be formally analyzed and used towards a wide range of autonomous system applications in computational intelligence and systems engineering. Output routines 820 may include software to generate and output signals to actuate and implement generated commands to autonomous sensor platforms, and generated intelligent behaviors for one or more self-aware mobile systems and/or autonomous sensor platforms. Operating system 822 may provide overall system functionality.

As shown in FIG. 8, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A mobile system comprising:
a vehicle, vessel, or aircraft comprising:
a plurality of video sensors, and a plurality of audial sensors, adapted to obtain information about surroundings of the vehicle, vessel, or aircraft and to transmit video and audial data representing the information about surroundings of the vehicle, vessel, or aircraft; and
at least one computer system adapted to receive the video and audial data from the plurality of sensors, perform fusion of the received data to generate information representing the surroundings of the vehicle, vessel, or aircraft, and to use the generated information to provide autonomous functioning of the vehicle, vessel, or aircraft.

2. The system of claim 1, further comprising digital signal processing circuitry adapted to filter the video and audial data to reduce noise.

3. The system of claim 2, wherein the computer system is further adapted to perform machine learning to generate improved tuning parameters for the digital signal processing circuitry adapted to filter the video and audial data.

4. The system of claim 1, wherein the generated information representing the surroundings of the vehicle, vessel, or aircraft is displayed to a human operator of the vehicle, vessel, or aircraft to provide automation assistance.

5. The system of claim 4, wherein the vehicle, vessel, or aircraft is a military or tactical vehicle and the generated information representing the surroundings of the vehicle, vessel, or aircraft is communicated with a human vehicle commander regarding when normal operations of a vehicle escalate into a combat response.

6. The system of claim 1, wherein the generated information representing the surroundings of the vehicle, vessel, or aircraft is used to provide full automation of the vehicle, vessel, or aircraft.

7. A method of implementing a mobile system comprising:
receiving data from a plurality of video sensors, and a plurality of audial sensors, adapted to obtain information about surroundings of the vehicle, vessel, or aircraft and to transmit video and audial data representing the information about surroundings of the vehicle, vessel, or aircraft, at least one computer system comprising a processor, memory accessible by the processor, and computer program instructions stored in the memory and executable by the processor; and
at the computer system, receiving the video and audial data from the plurality of sensors, performing fusion of the received data to generate information representing the surroundings of the vehicle, vessel, or aircraft, and using the generated information to provide autonomous functioning of the vehicle, vessel, or aircraft.

8. The method of claim 7, further comprising performing digital signal processing to filter the video and audial data to reduce noise.

9. The method of claim 8, further comprising performing machine learning to generate improved tuning parameters for the digital signal processing circuitry adapted to filter the video and audial data.

10. The method of claim 7, further comprising displaying the generated information representing the surroundings of the vehicle, vessel, or aircraft to a human operator of the vehicle, vessel, or aircraft to provide automation assistance.

11. The method of claim 10, wherein the vehicle, vessel, or aircraft is a military or tactical vehicle and further communicating the generated information representing the surroundings of the vehicle, vessel, or aircraft with a human vehicle commander regarding when normal operations of a vehicle escalate into a combat response.

12. The method of claim 7, further comprising using the generated information representing the surroundings of the vehicle, vessel, or aircraft to provide full automation of the vehicle, vessel, or aircraft.

13. A computer program product comprising a non-transitory computer readable storage having program instructions embodied therewith, the program instructions executable by a computer comprising a processor, memory accessible by the processor, and computer program instructions stored in the memory and executable by the processor, to cause the computer to perform a method comprising:
receiving data from a plurality of video sensors, and a plurality of audial sensors, adapted to obtain information about surroundings of the vehicle, vessel, or aircraft and to transmit video and audial data representing the information about surroundings of the vehicle, vessel, or aircraft, at least one computer system comprising a processor, memory accessible by the processor, and computer program instructions stored in the memory and executable by the processor; and
at the computer system, receiving the video and audial data from the plurality of sensors, performing fusion of the received data to generate information representing the surroundings of the vehicle, vessel, or aircraft, and using the generated information to provide autonomous functioning of the vehicle, vessel, or aircraft.

14. The computer program product of claim 13, further comprising performing digital signal processing to filter the video and audial data to reduce noise.

15. The computer program product of claim 14, further comprising performing machine learning to generate improved tuning parameters for the digital signal processing circuitry adapted to filter the video and audial data.

16. The computer program product of claim 13, further comprising displaying the generated information representing the surroundings of the vehicle, vessel, or aircraft to a human operator of the vehicle, vessel, or aircraft to provide automation assistance.

17. The computer program product of claim 16, wherein the vehicle, vessel, or aircraft is a military or tactical vehicle and further communicating the generated information representing the surroundings of the vehicle, vessel, or aircraft with a human vehicle commander regarding when normal operations of a vehicle escalate into a combat response.

18. The computer program product of claim 13, further comprising using the generated information representing the surroundings of the vehicle, vessel, or aircraft to provide full automation of the vehicle, vessel, or aircraft.
